(19) United States
(12) Patent Application Publication
(10) Pub. No.: US 2023/0410794 A1
(43) Pub. Date: Dec. 21, 2023

(54) AUDIO RECOGNITION METHOD, METHOD OF TRAINING AUDIO RECOGNITION MODEL, AND ELECTRONIC DEVICE

(71) Applicant: Beijing Baidu Netcom Science Technology Co., Ltd., Beijing (CN)

(72) Inventors: Xiaoyin FU, Beijing (CN); Mingshun YANG, Beijing (CN); Qiguang ZANG, Beijing (CN); Zhijie CHEN, Beijing (CN); Yangkai XU, Beijing (CN); Guibin WANG, Beijing (CN); Lei JIA, Beijing (CN)

(21) Appl. No.: 18/237,976

(22) Filed: Aug. 25, 2023

(30) Foreign Application Priority Data
Sep. 2, 2022 (CN) 202211068387.5

(51) Int. Cl. G10L 15/06; G10L 15/02; G10L 15/26

(52) U.S. Cl. CPC G10L 15/063; G10L 15/26; G10L 15/02

(57) ABSTRACT

An audio recognition method, a method of training an audio recognition model, and an electronic device are provided, which relate to fields of artificial intelligence, speech recognition, deep learning and natural language processing technologies. The audio recognition method includes: truncating an audio feature of target audio data to obtain at least one first audio sequence feature corresponding to a predetermined duration; obtaining, according to a peak information of the audio feature, a peak sub-information corresponding to the first audio sequence feature; performing at least one decoding operation on the first audio sequence feature to obtain a recognition result for the first audio sequence feature, a number of times the decoding operation is performed being identical to a number of peaks corresponding to the first audio sequence feature; obtaining target text data for the target audio data according to the recognition result for the at least one first audio sequence feature.

This application claims priority to Chinese Patent Application No. 202211068387.5, filed on Sep. 2, 2022, the entire content of which is incorporated herein in its entirety by reference.

### TECHNICAL FIELD

The present disclosure relates to a field of an artificial intelligence technology, in particular to fields of speech recognition, deep learning and natural language processing technologies. More specifically, the present disclosure provides an audio recognition method, a method of training an audio recognition model, an electronic device, and a storage medium.

### BACKGROUND

With a development of the artificial intelligence technology, a speech recognition technology is widely used in a smart speaker, a vehicle-mounted navigation, a smart customer service, a speech assistant, and other scenarios.

### SUMMARY

The present disclosure provides an audio recognition method, a method of training an audio recognition model, an electronic device, and a storage medium.

According to an aspect of the present disclosure, an audio recognition method is provided, including: truncating an audio feature of target audio data to obtain at least one first audio sequence feature, where a duration corresponding to the at least one first audio sequence feature is a predetermined duration; obtaining, according to a peak information of the audio feature, a peak sub-information corresponding to the first audio sequence feature, where the peak sub-information indicates a peak corresponding to the first audio sequence feature; performing at least one decoding operation on the first audio sequence feature to obtain a recognition result for the first audio sequence feature, where a number of times the decoding operation is performed is identical to a number of the peaks corresponding to the first audio sequence feature; and obtaining target text data for the target audio data according to the recognition result for the at least one first audio sequence feature.

According to another aspect of the present disclosure, a method of training an audio recognition model is provided, the audio recognition model includes a recognition sub-model, and the method includes: truncating an audio feature of sample audio data by using the recognition sub-model, so as to obtain at least one first audio sequence feature, where a duration corresponding to the at least one first audio sequence feature is a predetermined duration; obtaining, according to a sample peak information of the audio feature, a sample peak sub-information corresponding to the first audio sequence feature, where the sample peak sub-information indicates a sample peak corresponding to the first audio sequence feature; performing at least one decoding operation on the first audio sequence feature by using the recognition sub-model, so as to obtain a recognition result for the first audio sequence feature, where a number of times the decoding operation is performed is identical to a number of the sample peaks corresponding to the first audio sequence feature; obtaining sample text data for the sample audio data according to the recognition result for the at least one first audio sequence feature; determining a recognition loss value according to the sample text data and a recognition sub-label of the sample audio data; and training the audio recognition model according to the recognition loss value.

According to another aspect of the present disclosure, an electronic device is provided, including: at least one processor; and a memory communicatively connected to the at least one processor, where the memory stores instructions executable by the at least one processor, and the instructions, when executed by the at least one processor, are configured to cause the at least one processor to implement the methods provided in the present disclosure.

According to another aspect of the present disclosure, a non-transitory computer-readable storage medium having computer instructions therein is provided, and the computer instructions are configured to cause a computer to implement the methods provided in the present disclosure.

It should be understood that content described in this section is not intended to identify key or important features in embodiments of the present disclosure, nor is it intended to limit the scope of the present disclosure. Other features of the present disclosure will be easily understood through the following description.

### BRIEF DESCRIPTION OF THE DRAWINGS

The accompanying drawings are used for better understanding of the solution and do not constitute a limitation to the present disclosure, in which:

FIG. 1 shows a schematic diagram of an exemplary system architecture to which an audio recognition method and apparatus may be applied according to an embodiment of the present disclosure;

FIG. 2 shows a flowchart of an audio recognition method according to an embodiment of the present disclosure;

FIG. 3 shows a schematic diagram of an audio recognition method according to an embodiment of the present disclosure;

FIG. 4A to FIG. 4C show schematic diagrams of a streaming multi-layer truncated attention sub-model according to an embodiment of the present disclosure;

FIG. 5 shows a schematic diagram of a streaming multi-layer truncated attention sub-model according to another embodiment of the present disclosure;

FIG. 6 shows a schematic diagram of a classification network according to an embodiment of the present disclosure;

FIG. 7 shows a flowchart of a method of training an audio recognition model according to an embodiment of the present disclosure;

FIG. 8 shows a block diagram of an audio recognition apparatus according to an embodiment of the present disclosure;

FIG. 9 shows a block diagram of an apparatus of training an audio recognition model according to an embodiment of the present disclosure; and

FIG. 10 shows a block diagram of an electronic device to which an audio recognition method and/or a method of training an audio recognition model may be applied according to an embodiment of the present disclosure.

### DETAILED DESCRIPTION OF EMBODIMENTS

Exemplary embodiments of the present disclosure will be described below with reference to accompanying drawings, which include various details of embodiments of the present disclosure to facilitate understanding and should be considered as merely exemplary. Therefore, those ordinary skilled in the art should realize that various changes and modifications may be made to embodiments described herein without departing from the scope and spirit of the present disclosure. Likewise, for clarity and conciseness, descriptions of well-known functions and structures are omitted in the following description.

In technical solutions of the present disclosure, a collection, a storage, a use, a processing, a transmission, a provision, a disclosure and other processing of information involved comply with provisions of relevant laws and regulations, and do not violate public order and good custom.

In order to achieve an online speech interaction, it is possible to recognize input audio data as corresponding text data by using an Automatic Speech Recognition (ASR) module, perform a Natural Language Understanding (NLU) on the text data to obtain relevant semantic data, process the relevant semantic data to obtain corresponding response text data by using a Dialog Manager (DM) module, and then process the response text data to obtain output audio data by using a Text to Speech Synthesis (TTS) engine module, so as to perform a speech interaction.

The speech recognition module may include an acoustic model, a language model, and a decoder. To reduce complexity and computation, the language model and the acoustic model may be optimized separately as two independent models. With a continuous development of the deep learning technology, various modules of the acoustic model may be gradually replaced by neural networks, so that the complexity of the acoustic model may be simplified, a difficulty of model development and debugging may be reduced, and a performance of the speech recognition module may be significantly improved.

According to different modeling methods of neural networks for input audio features, the speech recognition technology may be classified into three methods, including feed-forward network modeling, recurrent temporal modeling, and autocorrelation modeling.

In some embodiments, a first acoustic model may be constructed based on a Deep Neural Network (DNN) model and a Hidden Markov Model (HMM) to replace a second acoustic model constructed based on a Gaussian Mixture Model (GMM) and a Hidden Markov Model. On an industrial-grade speech recognition module, a performance of the first acoustic model may be greatly improved, which may promote the speech recognition technology into an era of deep learning. The deep neural network is a feed-forward neural network. The feed-forward neural network may assume that the input audio feature has a contextual relationship within a fixed-length range, without considering a long-term feature dependency of speech recognition. On the basis of the first acoustic model, the deep neural network may be replaced by a network structure based on a recurrent neural network, such as Gate Recurrent Unit (GRU) or Long and Short Term Memory (LSTM), so as to further improve a modeling accuracy of the acoustic model.

In some embodiments, an End-to-End Connectionist Temporal Classification (CTC) model may be used to recognize a speech corresponding to a large vocabulary. In order to solve a problem of insufficient linguistic modeling ability of the connectionist temporal classification model, an end-to-end Listen, Attend and Spell (LAS) model based on attention mechanism may be used to perform a speech recognition. However, it is difficult for the listen, attend and spell model to achieve a streaming speech recognition. On this basis, it is possible to jointly model acoustics and language by using a Recurrent Neural Network (RNN) model, and then a RNN Transducer (RNN-T) model is obtained. The modeling method of connectionist temporal classification model based on long and short term memory and the modeling method of the RNN Transducer model substantially still belong to the recurrent temporal modeling method. Due to a temporal dependence, those modeling methods face problems of a weak global modeling ability and an inability to be applied to efficient parallel processing of massive data.

The recurrent neural network, the long and short term memory and other models based on recurrent temporal modeling have a context modeling ability. However, in the recurrent temporal modeling, an information transmission is performed in a manner of frame-by-frame recursion, and there is still a problem of a weak global modeling ability. Through a gating mechanism, the long and short term memory model may alleviate the problem of insufficient long-term modeling ability of the recurrent neural network model to a certain extent. However, in a case of an error in the model, such error information may gradually amplify over time, thus affecting the modeling ability of the model. In addition, during computation, the recurrent neural network model may perform a computation at a next time instant after a computation at a previous time instant is completed. Due to the temporal dependency in computation, a high-speed parallel computing characteristic of a Graphics processing unit (GPU) may not be effectively utilized during model training, and the training speed is not high. When training with hundreds of thousands of hours of industrial-grade training data, the training efficiency of the recurrent neural network model is not high. In addition, a trained recurrent neural network model has a poor recognition performance.

In some embodiments, a Transformer model based on autocorrelation modeling may be adopted in order to solve the problems existing in the recurrent temporal modeling. Different from the recurrent neural network model, the Transformer model may perform an autocorrelation modeling on a feature information at any position by using the attention mechanism. Compared with the recurrent temporal modeling method, the autocorrelation modeling method may more intuitively reflect a relationship between features and has a stronger modeling ability. When calculating based on a self-attention mechanism, features at different time instants may be calculated simultaneously, and the parallel computing ability of the graphics processing unit may be utilized more effectively.

In some embodiments, the Transformer model may be enhanced by convolution using a Convolutional Neural Network (CNN) model, and then a Conformer model is obtained. The Conformer model combines a long-distance relationship modeling ability of the Transformer model and a local modeling ability of the convolutional neural network model, so that the performance of the speech recognition module may be improved. However, the Transformer model or the Conformer model may start decoding only after all audio is input, which may not meet a requirement of a streaming speech recognition in an online speech interaction system.

In some embodiments, in order to meet a requirement of a real-time output of a recognition result in a streaming speech recognition task, it is possible to combine the RNN Transducer model and the listen, attend and spell model to obtain a two-pass recognition module. When performing a speech recognition using the second-pass recognition module, a recognition result may be obtained using the RNN Transducer model, and then an intermediate feature may be obtained using the recognition result, so that a secondary recognition may be performed using the listen, attend and spell model.

In some embodiments, the two-pass recognition system has a low response speed, and may not meet a requirement of the online speech interaction task on a system delay. Based on this, the listen, attend and spell model may be replaced by the Transformer model to perform the secondary recognition on the recognition result of the RNN Transducer model. In addition, it is possible to reduce a quantity of parameters of the RNN Transducer model to improve the response speed of the system. Such secondary recognition method has both recurrent temporal modeling ability and autocorrelation modeling ability, but still faces problems of a weak global modeling ability and an inability to efficiently process massive data in parallel.

A recognition module that combines the recurrent temporal modeling and the autocorrelation modeling may perform a secondary decoding. A second decoding may be performed after an output of a recognition result from a first decoding. Such secondary decoding method further increases the system delay, and may not meet a requirement for a low delay of speech recognition in the speech interaction task. In addition, the recognition module that combines the recurrent temporal modeling and the autocorrelation modeling still faces the problems of low computing efficiency and poor modeling accuracy of the recurrent neural network, and it is difficult to complete a task of quickly and efficiently training a large-parameter model with massive training data in a timely manner. Furthermore, such recognition module has a poor recognition performance. In addition, there may be some differences between a first recognition result and a second recognition result, which makes it difficult for subsequent modules of the speech interaction system to effectively utilize the first recognition result for an early calculation, resulting in large redundant computation and high delay in the speech interaction system.

In some embodiments, an end-to-end streaming speech recognition module based on historical feature abstraction may be used to perform a speech recognition. Such module applies the Transformer model to a streaming speech recognition system, and solves both problems of “memory explosion” and “computation explosion” that the Transformer model faces in long audio training and decoding. Such module may truncate an audio feature into continuous feature segments with unequal lengths according to a peak information output by the connectionist temporal classification model, and then perform a historical feature abstraction on those feature segments layer by layer according to a hidden feature output by a decoder. Through the historical feature abstraction, the feature segment may be abstracted into an information representation containing a text, so that a streaming decoding is achieved using the Transformer model, and a problem of a large memory consumption during computation of the Transformer model may be solved.

According to the peak information of the connectionist temporal classification model, the end-to-end streaming speech recognition module based on historical feature abstraction may truncate the audio feature and drive the decoder to decode. In a speech interaction, a speech speed of an object may change constantly, and a feature length between peaks changes accordingly. Audio feature segments obtained according to the peak information have different lengths, and a memory space of the graphics processing unit may not be fully utilized, resulting in a low efficiency of training and inference. For example, in a case of different lengths of the audio feature segments, in order to perform parallel computing using the graphics processing unit, a specific value may be added to the audio feature segment, so that the different lengths of the audio feature segments may be adjusted to equal. However, adding the specific value may cause the adjusted audio feature segments to occupy more memory space and to require more computing resources for decoding, resulting in low efficiency of training and inference.

In addition, the speech recognition module and the connectionist temporal classification model share a same model parameter, which increases a difficulty of model adjustment and optimization. The online speech interaction has a variety of task scenarios, and for different interaction tasks, it is required to optimize the connectionist temporal classification model and the speech recognition module simultaneously, which results in a low efficiency of model update iterations.

FIG. 1 shows a schematic diagram of an exemplary system architecture to which an audio recognition method and apparatus may be applied according to an embodiment of the present disclosure.

It should be noted that FIG. 1 is merely an example of the system architecture to which embodiments of the present disclosure may be applied, so as to help those skilled in the art understand technical contents of the present disclosure. However, it does not mean that embodiments of the present disclosure may not be applied to other devices, systems, environments or scenarios.

As shown in FIG. 1, a system architecture 100 according to such embodiments may include an audio recognition module 101, a natural language understanding module 102, a dialogue generation module 103, and a speech synthesis module 104. The system architecture 100 may be applied to an online speech interaction scenario.

The speech recognition module 101 may recognize input target audio data as corresponding text data. The natural language understanding module 102 may perform a natural language understanding on the text data to obtain relevant semantic data. The dialog generation module 103 may process the relevant semantic data to obtain corresponding response text data. The speech synthesis module may process the response text data to obtain output audio data, so as to perform a speech interaction.

In some embodiments, the audio recognition module 101, the natural language understanding module 102, the dialog generation module 103 and the speech synthesis module 104 may be respectively deployed in different servers (or server clusters). Those different servers (or server clusters) may communicate with each other through a network. The network is a medium for providing a communication link between different servers. The network may include various connection types, such as wired and/or wireless communication links, or the like. A terminal device may be used by a user to interact with the servers deployed with the audio recognition module 101 and other modules through the network, so as to send the target audio data and receive the output audio data. The terminal device may be deployed with an audio acquisition device (such as a microphone), and may also be deployed with an audio playback device. The terminal device may be various electronic devices that have a display screen and support web browsing, including but not limited to smartphones, tablet computers, laptop computers, desktop computers, and the like.

In some other embodiments, one or more of the audio recognition module 101, the natural language understanding module 102, the dialog generation module 103 and the speech synthesis module 104 may also be deployed in the terminal device. For example, the audio recognition module 101 may be deployed in the terminal device, while the natural language understanding module 102, the dialogue generation module 103 and the speech synthesis module 104 may be deployed in different servers (or server clusters).

It may be understood that the audio recognition method provided in the present disclosure may be performed by a server, a server cluster or a terminal device deployed with the audio recognition module 101.

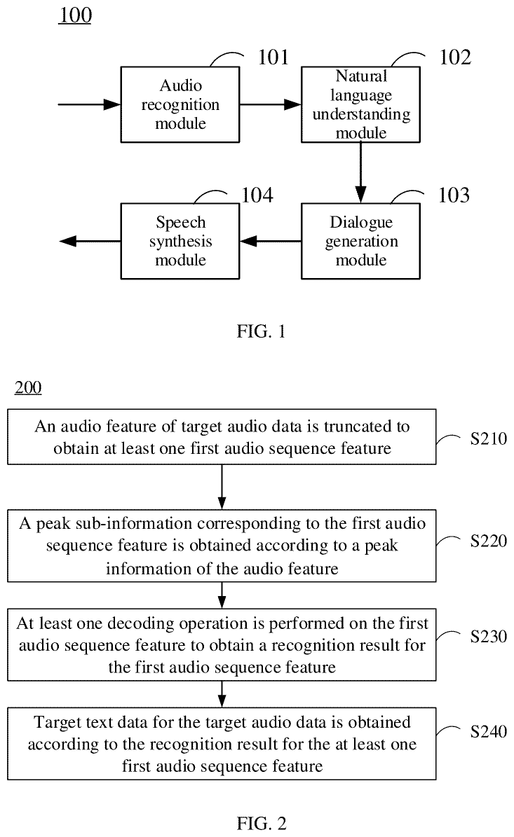

FIG. 2 shows a flowchart of an audio recognition method according to an embodiment of the present disclosure.

As shown in FIG. 2, a method 200 may include operation S210 to operation S240.

In operation S210, an audio feature of target audio data is truncated to obtain at least one first audio sequence feature.

In embodiments of the present disclosure, Mel spectrum data of the target audio data may be acquired so as to obtain the audio feature.

In embodiments of the present disclosure, the target audio data may correspond to various languages. For example, the target audio data may correspond to Chinese. For another example, the target audio data may correspond to English.

In embodiments of the present disclosure, a duration corresponding to the at least one first audio sequence feature is a predetermined duration.

In embodiments of the present disclosure, in a case that the number of first audio sequence features is multiple, each of the first audio sequence features may correspond to the predetermined duration. For example, the duration corresponding to the first audio sequence feature may be 1 second. For another example, the duration corresponding to the first audio sequence feature may be 10 milliseconds.

For another example, after the audio feature is received, at a 1^{st} second, the audio feature may be truncated to obtain a 1^{st} first audio sequence feature, and at a 2^{nd} second, the audio feature may be truncated to obtain a 2^{nd} first audio sequence feature. The duration corresponding to each of the 1^{st} first audio sequence feature and the 2^{nd} first audio sequence feature may be one second.

In operation S220, a peak sub-information corresponding to the first audio sequence feature is obtained according to a peak information of the audio feature.

In embodiments of the present disclosure, the peak sub-information is used to indicate a peak corresponding to the first audio sequence feature. For example, the peak may correspond to a value. In an example, different peaks may correspond to different values. In another example, different peaks may correspond to identical values.

In embodiments of the present disclosure, the peak information may be determined according to the audio feature. Then, the peak sub-information corresponding to the first audio sequence feature is determined according to the peak information. For example, the peak information is generated according to the audio feature. According to a time period corresponding to the first audio sequence feature, the peak sub-information corresponding to the time period may be obtained from the peak information. The peak sub-information is determined as the peak sub-information corresponding to the first audio sequence feature. For another example, the peak information may be determined using various methods.

In operation S230, at least one decoding operation is performed on the first audio sequence feature to obtain a recognition result for the first audio sequence feature.

In embodiments of the present disclosure, the number of times that the decoding operation is performed is identical to the number of peaks corresponding to the first audio sequence feature. For example, if the first audio sequence feature corresponds to two peaks, the decoding operation may be performed two times.

In embodiments of the present disclosure, after a first audio sequence feature is obtained, at least one decoding operation may be performed on the first audio sequence feature according to the peak sub-information corresponding to the first audio sequence feature. For example, after the 1^{st} first audio sequence feature is obtained, the number of peaks corresponding to the 1^{st} first audio sequence feature may be used as the number of times the decoding operation is performed on the 1^{st} first audio sequence feature, so that at least one decoding operation is performed on the 1^{st} first audio sequence feature to obtain a 1^{st} recognition result. If a 2^{nd} first audio sequence feature is obtained during a process of decoding the 1^{st} first audio sequence feature or after the decoding of the 1^{st} first audio sequence feature is completed, the number of peaks corresponding to the 2^{nd} first audio sequence feature may be used as the number of times the decoding operation is performed on the 2^{nd} first audio sequence feature, so that at least one decoding operation is performed on the 2^{nd} first audio sequence feature to obtain a 2^{nd} recognition result.

In embodiments of the present disclosure, the recognition result may refer to recognition results in various languages. For example, in a case that the target audio data corresponds to Chinese, the recognition result may contain at least one Chinese character. For example, in a case that the target audio data corresponds to English, the recognition result may contain at least one English word or word piece. It may be understood that an English word may be composed of one or more word pieces.

In operation S240, target text data for the target audio data is obtained according to at least one recognition result.

In embodiments of the present disclosure, at least one recognition result may be fused as the target text data. For example, the 1^{st} recognition result and the 2^{nd} recognition result may be concatenated as the target text data.

Through embodiments of the present disclosure, by truncating the audio feature into the first audio sequence feature with the predetermined length, it is possible to efficiently and quickly acquire the first audio sequence feature and perform subsequent processing, which helps to improve the efficiency of audio recognition. In addition, in a case that the plurality of first audio sequence features have identical lengths, the graphics processing unit may be effectively utilized to perform parallel computing, so as to further improve the efficiency of audio recognition.

In addition, through embodiments of the present disclosure, it is not required to overly rely on other information when truncating the audio feature, and the truncation may be performed even if the peak information is not obtained in a timely manner, so that the efficiency of obtaining the first audio sequence feature is improved, and a time and overhead of parsing the peak information may be saved, which may further improve the efficiency of obtaining the first audio sequence feature, reduce a resource overhead, and is more suitable for online speech interaction scenarios. While inputting the target audio data, it is possible to output partial recognition result, so that the natural language understanding module 102, the dialogue generation module 103 and the speech synthesis module 104 may perform relevant operations in advance, then the redundant computation may be reduced, the response time of the system architecture 100 may be reduced, and the computing resources of the system architecture may be saved.

In addition, through embodiments of the present disclosure, for a first audio sequence feature, the number of times the decoding operation is performed is identical to the number of peaks, so that the number of times of decoding the first audio sequence feature may be ensured, and the accuracy of audio recognition may not be reduced. In addition, the decoding may be performed accurately when the number of peaks is accurate, and a requirement for the accuracy of position information of the peaks is reduced. Thus, the first audio sequence feature may be efficiently obtained, the decoding may be efficiently and accurately performed, and the audio recognition accuracy and the computing efficiency may be effectively balanced.

In addition, through embodiments of the present disclosure, at least one decoding operation may be performed using a Conformer model or a Transformer model, etc. Then, the dependence on temporal information may be reduced or eliminated, and the first audio sequence features in different time periods may be directly processed, which may reduce or avoid a gradual transmission of error information along with the temporal information, and improve the model accuracy. In addition, the Conformer model or the Transformer model, etc. is more in line with the characteristics of the graphics processing unit, which may help to use parallel computing to accelerate the decoding.

It may be understood that the target audio data may be acquired gradually. For example, if a target object provides an audio signal corresponding to two words at a 1^{st} second, an audio signal corresponding to one word at a 2^{nd} second, and an audio signal corresponding to one word at a 3^{rd} second, then at the 1^{st} second, after the audio signal is received, the audio signal may be converted into partial target audio data, and at the 3^{rd} second, when all audio signals are acquired, the whole target audio data may be obtained.

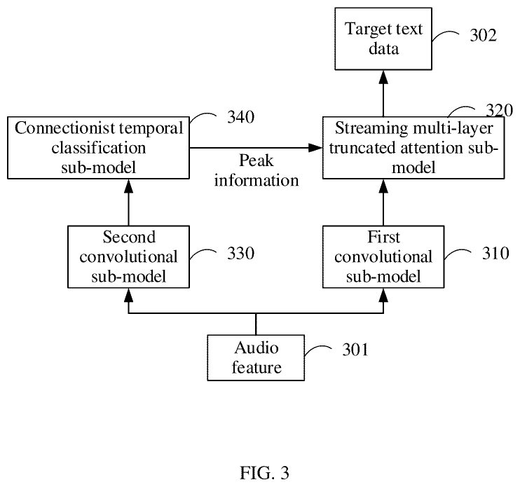

It may be understood that an implementation process of the method provided in the present disclosure has been described above. A principle of the method provided in the present disclosure will be described in detail below with reference to FIG. 3.

FIG. 3 shows a schematic diagram of an audio recognition method according to an embodiment of the present disclosure.

As shown in FIG. 3, an audio feature 301 may be obtained by performing a feature extraction on the target audio data. In embodiments of the present disclosure, the audio recognition method may be implemented by an audio recognition model. The audio recognition model may include a first convolutional sub-model 310, a streaming multi-Layer truncated attention (SMLTA) sub-model 320, a second convolutional sub-model 330, and a connectionist temporal classification sub-model 340.

In embodiments of the present disclosure, truncating the audio feature of the target audio data may include: performing a convolution on the audio feature to obtain a first audio feature; and truncating the first audio feature.

For example, as shown in FIG. 3, a convolution may be performed on an audio feature 301 by using the first convolutional sub-model 310, so as to obtain the first audio feature. Then, the first audio feature may be truncated using the streaming multi-layer truncated attention sub-model 320, so as to obtain at least one first audio sequence feature. For another example, the streaming multi-layer truncated attention sub-model may be used to determine whether a duration corresponding to the first audio feature meets a predetermined duration condition or not; and truncate the first audio feature in response to a determination that the duration corresponding to the first audio feature meets the predetermined duration condition. In an example, the predetermined duration condition may refer to, for example, that an increment of the duration is a predetermined time increment threshold. The predetermined time increment threshold may be, for example, 1 second. Thus, the first audio feature may be truncated once per second.

In embodiments of the present disclosure, obtaining the peak sub-information corresponding to the first audio sequence feature according to the peak information of the audio feature may include: performing a convolution on the audio feature to obtain a second audio feature; and obtaining the peak sub-information corresponding to the first audio sequence feature according to the peak information of the second audio feature.

For example, as shown in FIG. 3, a convolution may be performed on the audio feature 301 by using the second convolutional sub-model 330, so as to obtain a second audio feature. Then, the second audio feature may be processed by using the connectionist temporal classification sub-model 340 to obtain the peak information. The peak information is input into the streaming multi-layer truncated attention sub-model 320, so as to determine the peak sub-information corresponding to the truncated first audio sequence feature. It may be understood that both the first audio feature and the second audio feature are obtained by performing a convolution on the audio feature. The peak sub-information corresponding to the first audio sequence feature may be determined based on the time period corresponding to the first audio sequence feature.

In embodiments of the present disclosure, the first convolutional sub-model 310 may include a plurality of stacked convolutional layers. For example, each convolutional layer may perform convolution down-sampling with a stride of 2. For another example, a frame rate corresponding to the first audio feature may be ¼ of that of the audio feature 301.

In embodiments of the present disclosure, the second convolutional sub-model 330 may include a plurality of stacked convolutional layers. For example, each convolutional layer may perform convolution down-sampling with a stride of 2. For another example, a frame rate corresponding to the second audio feature may be ¼ of that of the audio feature 301.

In embodiments of the present disclosure, the first convolutional sub-model 310 and the second convolutional sub-model 330 may have identical structures. For example, the number of convolutional layers of the first convolutional sub-model 310 may be identical to the number of convolutional layers of the second convolutional sub-model 330. Through embodiments of the present disclosure, by performing convolution down-sampling on the audio feature, it is possible to effectively obtain a deep information from the audio feature, and improve the performance of the audio recognition model. In addition, as the first convolutional sub-model 310 and the second convolutional sub-model 330 have identical structures, the graphics processing unit may be fully utilized to perform parallel processing, so as to further improve the performance of the audio recognition model.

Then, the first audio sequence feature may be decoded at least once by using the streaming multi-layer truncated attention sub-model to obtain the recognition result. For example, the 1^{st} first audio sequence feature is decoded at least once by using a decoding network of the streaming multi-layer truncated attention sub-model, so as to obtain the 1^{st} recognition result. For another example, the 2^{nd} first audio sequence feature is decoded at least once by using the decoding network of the streaming multi-layer truncated attention sub-model, so as to obtain the 2^{nd} recognition result. Target text data 302 may be obtained according to the two recognition results.

It may be understood that in embodiments of the present disclosure, in addition to the streaming multi-layer truncated attention sub-model, a multi-layer Transformer model may also be used to perform multi-level encoding and decoding on the first audio sequence feature, so as to obtain the target text data.

It may be understood that in embodiments of the present disclosure, in addition to the connectionist temporal classification sub-model, various other models may also be used to determine the peak information of the audio feature.

It may be understood that the principle of the audio recognition method in the present disclosure has been described in detail above. The streaming multi-layer truncated attention sub-model in the present disclosure will be described in detail below in conjunction with related embodiments.

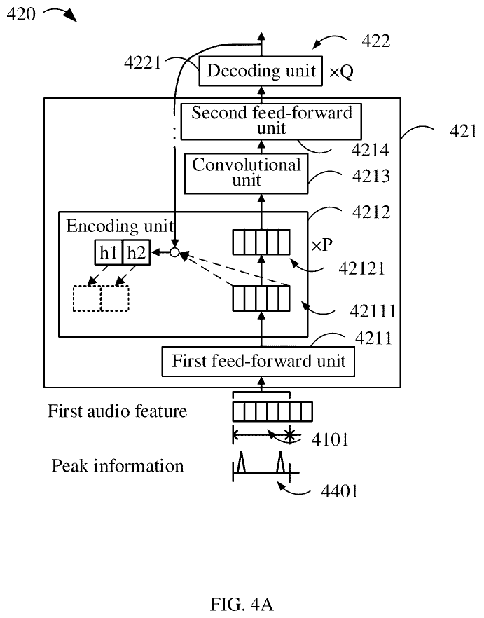

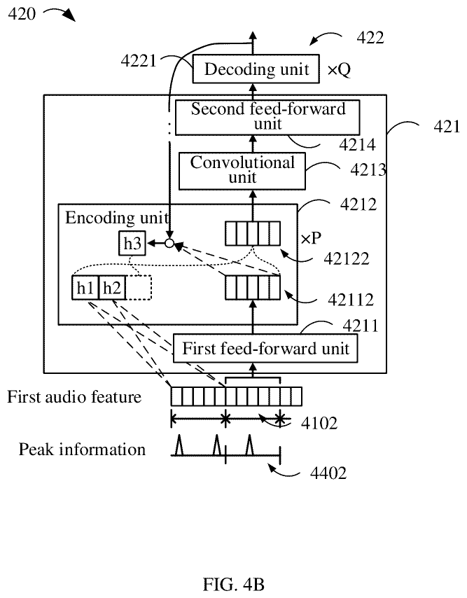

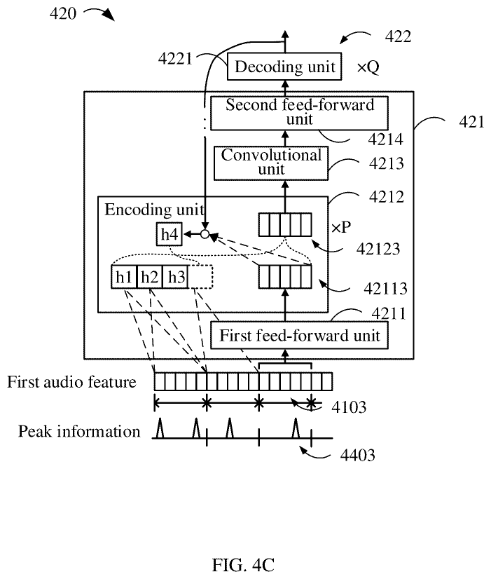

In some embodiments, the number of first audio sequence features is K, a recognition result for a k^{th} first audio sequence feature among K first audio sequence features includes I recognition sub-results, and the k^{th} first audio sequence feature corresponds to I peaks. I is an integer greater than or equal to 1, k is an integer greater than or equal to 1 and less than or equal to K, and K is an integer greater than 1. A detailed description will be given below with reference to FIG. 4A to FIG. 4C.

FIG. 4A to FIG. 4C show schematic diagrams of the streaming multi-layer truncated attention sub-model according to an embodiment of the present disclosure.

As shown in FIG. 4A to FIG. 4C, a streaming multi-layer truncated attention sub-model 420 may include an encoding network 421 and a decoding network 422. The encoding network 421 may include a first feed-forward unit 4211, P encoding units 4212, a convolutional unit 4213, and a second feed-forward unit 4214. The decoding network 422 may include Q decoding units 4221. Q is an integer greater than or equal to 1. P is an integer greater than or equal to 1.

In embodiments of the present disclosure, performing at least one decoding operation on the first audio sequence feature may include: encoding the k^{th} first audio sequence feature to obtain a k^{th} initial audio sequence encoding feature; and obtaining a k^{th} target audio sequence encoding feature according to the k^{th} initial audio sequence encoding feature.

For example, after a 1^{st} predetermined duration (for example, 1 second) of the target audio data is acquired, the first audio feature of the target audio data may be truncated to obtain a 1^{st} first audio sequence feature 4101. The 1^{st} first audio sequence feature 4101 may be encoded using the first feed-forward unit 4211 to obtain a 1^{st} initial audio sequence encoding feature 42111. Then, based on a self-attention mechanism, the 1^{st} initial audio sequence encoding feature 42111 may be encoded using the encoding unit 4212 to obtain a 1^{st} target audio sequence encoding feature 42121.

Then, a convolution may be performed on the 1^{st} target audio sequence encoding feature 42121 by using the convolutional unit 4213, so as to obtain a 1^{st} convoluted audio sequence encoding feature. The 1^{st} convoluted audio sequence encoding feature may be processed using the second feed-forward unit 4214 to obtain a 1^{st} processed audio sequence encoding feature.

For another example, after the 1^{st} predetermined duration (for example, 1 second) of the target audio data is acquired, a peak sub-information 4401 corresponding to the 1^{st} first audio sequence feature 4101 may be determined from the peak information output by the connectionist temporal classification sub-model. As shown in FIG. 4A, the peak sub-information 4401 may indicate that the 1^{st} first audio sequence feature 4101 corresponds to two peaks.

In embodiments of the present disclosure, performing at least one decoding operation on the first audio sequence feature may include: in response to a determination that the first audio sequence feature meets a recognition start condition, performing at least one decoding operation on the first audio sequence feature according to a first predetermined decoding parameter information, so as to obtain an original decoding parameter information and a recognition result for the first audio sequence feature.

For example, the recognition start condition may refer to that the first audio sequence feature is a 1^{st} audio sequence feature truncated from the audio feature. It may be determined whether the 1^{st} first audio sequence feature 4101 meets the recognition start condition or not using various methods. I decoding operations may be performed on the 1^{st} first audio sequence feature 4101 according to the first predetermined decoding parameter information, so as to obtain the original decoding parameter information and I recognition sub-results. In an example, the first predetermined decoding parameter information may include a sentence prefix of the decoding unit. As described above, the peak sub-information 4401 may indicate that the 1^{st} first audio sequence feature 4101 corresponds to two peaks. It may be understood that I may be 2 for the 1^{st} first audio sequence feature 4101.

In embodiments of the present disclosure, performing at least one decoding operation on the first audio sequence feature may include: performing a 1^{st} decoding operation on the k^{th} first audio sequence feature according to an initial decoding parameter information of the k^{th} first audio sequence feature, so as to obtain a 1^{st} decoding parameter information of the k^{th} first audio sequence feature and a 1^{st} recognition sub-result for the k^{th} first audio sequence feature. For example, the first predetermined decoding parameter information may be used as the initial decoding parameter information of the 1^{st} first audio sequence feature 4101. Then, a 1^{st} decoding operation may be performed on a 1^{st} processed audio sequence encoding feature to obtain the 1^{st} decoding parameter information of the 1^{st} first audio sequence feature 4101 and also obtain the 1^{st} recognition sub-result for the 1^{st} first audio sequence feature 4101. In an example, the 1^{st} recognition sub-result may be a Chinese character.

In embodiments of the present disclosure, performing at least one decoding operation on the first audio sequence feature may include: performing an i^{th} decoding operation on the k^{th} first audio sequence feature according to an (i−1)^{th} decoding parameter information of the k^{th} first audio sequence feature, so as to obtain an i^{th} decoding parameter information of the k^{th} first audio sequence feature and an i^{th} recognition sub-result for the k^{th} first audio sequence feature. In addition, in embodiments of the present disclosure, performing the i^{th} decoding operation on the k^{th} first audio sequence feature may include: performing an I^{th} decoding operation on the k^{th} first audio sequence feature according to an (I−1)^{th} decoding parameter information of the k^{th} first audio sequence feature, so as to obtain an I^{th} decoding parameter information of the k^{th} first audio sequence feature and an I^{th} recognition sub-result for the k^{th} first audio sequence feature.

For example, i is an integer greater than 1 and less than or equal to I. For another example, as described above, I may be 2 for the 1^{st} first audio sequence feature 4101. In a case of i=I=2, a 2^{nd} decoding operation may be performed on the 1^{st} processed audio sequence encoding feature according to the 1^{st} decoding parameter information of the 1^{st} first audio sequence feature 4101, so as to obtain a 2^{nd} decoding parameter information of the 1^{st} first audio sequence feature 4101 and also obtain a 2^{nd} recognition sub-result for the 1^{st} first audio sequence feature 4101. In an example, the 2^{nd} recognition sub-result may also be a Chinese character. For example, Q-level decoding may be performed on the 1^{st} processed audio sequence encoding feature using the Q decoding units 4221, so as to implement a decoding operation once.

After two decoding operations are performed, the 1^{st} recognition sub-result and the 2^{nd} recognition sub-result for the 1^{st} first audio sequence feature 4101 may be used as the recognition result for the 1^{st} first audio sequence feature 4101.

It may be understood that some methods of encoding and decoding the 1^{st} first audio sequence feature have been described in detail above with reference to FIG. 4A. After the recognition result is obtained, the streaming multi-layer truncated attention sub-model may further determine a historical feature, so as to encode a subsequent first audio sequence feature based on a historical attention mechanism. A detailed description will be provided below with reference to FIG. 4A.

In embodiments of the present disclosure, performing at least one decoding operation on the first audio sequence feature may include: obtaining a 1^{st} historical sub-feature of the k^{th} first audio sequence feature according to the 1^{st} recognition sub-result for the k^{th} first audio sequence feature and the k^{th} initial audio sequence encoding feature. For example, as shown in FIG. 4A, a 1^{st} historical sub-feature h1 of the 1^{st} first audio sequence feature 4101 may be obtained by encoding according to the 1^{st} recognition sub-result for the 1^{st} first audio sequence feature 4101 and the 1^{st} initial audio sequence encoding feature 42111.

In embodiments of the present disclosure, performing at least one decoding operation on the first audio sequence feature may further include: obtaining an i^{th} historical sub-feature of the k^{th} first audio sequence feature according to the i^{th} recognition sub-result for the k^{th} first audio sequence feature and the k^{th} initial audio sequence encoding feature. For example, as shown in FIG. 4A, in a case of i=I=2, a 2^{nd} historical sub-feature h2 of the 1^{st} first audio sequence feature 4101 may be obtained by encoding according to the 2^{nd} recognition sub-result for the 1^{st} first audio sequence feature 4101 and the 1^{st} initial audio sequence encoding feature 42111.

In embodiments of the present disclosure, performing at least one decoding operation on the first audio sequence feature may further include: in a case of k=1, fusing I historical sub-features of the k^{th} first audio sequence feature to obtain a historical feature related to a (k+1)^{th} first audio sequence feature. For example, as shown in FIG. 4A, the 1^{st} historical sub-feature h1 of the 1^{st} first audio sequence feature 4101 and the 2^{nd} historical sub-feature h2 of the 1^{st} first audio sequence feature 4101 may be concatenated to obtain a historical feature related to the 2^{nd} first audio sequence feature.

In addition, in embodiments of the present disclosure, performing at least one decoding operation on the k^{th} first audio sequence feature may further include: in a case that k is less than K, using the I^{th} decoding parameter information of the k^{th} first audio sequence feature as the initial decoding parameter information of the (k+1)^{th} first audio sequence feature. For example, the 2^{nd} decoding parameter information of the 1^{st} first audio sequence feature 4101 may be used as the initial decoding parameter information of the 2^{nd} first audio sequence feature.

It may be understood that some methods of encoding and decoding the b 1^{st} first audio sequence feature and some methods of processing the recognition result for the 1^{st} first audio sequence feature based on the historical attention mechanism are described above in detail. Some methods of encoding and decoding the 2^{nd} first audio sequence feature will be described in detail below in conjunction with related embodiments.

As shown in FIG. 4B, after two predetermined durations (for example, 2 seconds) of target audio data are acquired, the first audio feature of the target audio data may be truncated to obtain a 2^{nd} first audio sequence feature 4102. As shown in FIG. 4A and FIG. 4B, the 1^{st} first audio sequence feature 4101 and the 2^{nd} first audio sequence feature 4102 may correspond to a same duration. In an example, the duration corresponding to the 1^{st} first audio sequence feature 4101 and the duration corresponding to the 2^{nd} first audio sequence feature 4102 are both one second.

The 2^{nd} first audio sequence feature 4102 may be encoded using the first feed-forward unit 4211 to obtain a 2^{nd} initial audio sequence encoding feature 42112.

In embodiments of the present disclosure, obtaining the k^{th} target audio sequence encoding feature according to the k^{th} initial audio sequence encoding feature may include: obtaining the k^{th} target audio sequence encoding feature according to the historical feature related to the k^{th} first audio sequence feature and the k^{th} initial audio sequence encoding feature. For example, based on the self-attention mechanism, the encoding unit 4212 may perform encoding according to the 2^{nd} initial audio sequence encoding feature 42112, the 1^{st} historical sub-feature h1 and the 2^{nd} historical sub-feature h2, so as to obtain the 2^{nd} target audio sequence encoding feature 42122.

Then, a convolution may be performed on the 2^{nd} target audio sequence encoding feature 42122 by using the convolutional unit 4213, so as to obtain a 2^{nd} convoluted audio sequence encoding feature. The 2^{nd} convoluted audio sequence encoding feature may be processed using the second feed-forward unit 4214 to obtain a 2^{nd} processed audio sequence encoding feature.

For another example, after two predetermined durations (for example, 2 seconds) of target audio data are acquired, a peak sub-information 4402 corresponding to the 2^{nd} first audio sequence feature 4102 may be determined from the peak information output by the connectionist temporal classification sub-model. As shown in FIG. 4B, the peak sub-information 4402 may indicate that the 2^{nd} first audio sequence feature 4102 corresponds to one peak. It may be understood that I may be 1 for the 2^{nd} first audio sequence feature 4102.

For another example, as described above, the 2^{nd} decoding parameter information of the 1^{st} first audio sequence feature 4101 is used as the initial decoding parameter information of the 2^{nd} first audio sequence feature. Then, a 1^{st} decoding operation may be performed on the 2^{nd} processed audio sequence encoding feature, so as to obtain the 1^{st} decoding parameter information of the 2^{nd} first audio sequence feature 4102 and also obtain the 1^{st} recognition sub-result (for example, a Chinese character) for the 2^{nd} first audio sequence feature 4102.

After the decoding operation is performed once, the 1^{st} recognition sub-result for the 2^{nd} first audio sequence feature 4102 may be used as the recognition result for the 2^{nd} first audio sequence feature 4102.

It may be understood that some methods of encoding and decoding the first audio sequence feature have been described in detail above with reference to FIG. 4B. Some methods of determining I historical sub-features of the 2^{nd} first audio sequence feature will be described in detail below with reference to FIG. 4B.

For example, as shown in FIG. 4B, a 1^{st} historical sub-feature h3 of the 2^{nd} first audio sequence feature 4102 may be obtained by encoding according to the 1^{st} recognition sub-result for the 2^{nd} first audio sequence feature 4102 and the 2^{nd} initial audio sequence encoding feature 42112.

In embodiments of the present disclosure, performing at least one decoding operation on the first audio sequence feature may further include: in a case of k=K, fusing the I historical sub-features of the K^{th} first audio sequence feature and the historical feature related to the K^{th} first audio sequence feature to obtain a historical feature related to a next audio sequence feature. For example, as shown in FIG. 4B, the 1^{st} historical sub-feature h1 of the 1^{st} first audio sequence feature 4101, the 2^{nd} historical sub-feature h2 of the 1^{st} first audio sequence feature 4101 and the 1^{st} historical sub-feature h3 of the 2^{nd} first audio sequence feature 4102 may be concatenated to obtain a historical feature related to the next audio sequence feature.

As shown in FIG. 4C, after three predetermined durations (for example, 3 seconds) of target audio data are acquired, the first audio feature of the target audio data may be truncated to obtain an audio sequence feature. If it is determined that the audio sequence feature meets a recognition end condition, it may be determined that a second audio sequence feature 4103 is truncated from the first audio feature. For example, the recognition end condition may refer to that the audio sequence feature is a last audio sequence feature of the first audio feature.

As shown in FIG. 4A, FIG. 4B and FIG. 4C, the 1^{st} first audio sequence feature 4101, the 2^{nd} first audio sequence feature 4102 and the second audio sequence feature 4103 correspond to the same duration. In an example, the duration corresponding to the 1^{st} first audio sequence feature 4101, the duration corresponding to the 2^{nd} first audio sequence feature 4102 and the duration corresponding to the second audio sequence feature 4103 are all one second.

The second audio sequence feature 4103 may be encoded using the first feed-forward unit 4211 to obtain a 3^{rd} initial audio sequence encoding feature 42113.

For example, based on the self-attention mechanism, the encoding unit 4212 may perform encoding according to the 3^{rd} initial audio sequence encoding feature 42113, the 1^{st} historical sub-feature h1 of the 1^{st} first audio sequence feature 4101, the 2^{nd} historical sub-feature h2 of the 1^{st} first audio sequence feature 4101, and the 1^{st} historical sub-feature h3 of the 2^{nd} first audio sequence feature 4102, so as to obtain a 3^{rd} target audio sequence encoding feature 42123.

Then, a convolution may be performed on the 3^{rd} target audio sequence encoding feature 42123 by using the convolutional unit 4213, so as to obtain a 3^{rd} convoluted audio sequence encoding feature. The 3^{rd} convoluted audio sequence encoding feature may be processed using the second feed-forward unit 4214 to obtain a 3^{rd} processed audio sequence encoding feature.

For another example, after three predetermined durations (for example, 3 seconds) of target audio data are acquired, a peak sub-information 4403 corresponding to the second audio sequence feature 4103 may be determined from the peak information output by the connectionist temporal classification sub-model. As shown in FIG. 4C, the peak sub-information 4403 may indicate that the second audio sequence feature 4103 corresponds to one peak. It may be understood that for the second audio sequence feature 4103, the number of times the decoding operation is performed is less than or equal to the number of peaks corresponding to the second audio sequence feature.

In embodiments of the present disclosure, obtaining the target text data for the target audio data according to the recognition result for the at least one first audio sequence feature may include: in response to the second audio sequence feature being truncated from the audio feature, performing at least one decoding operation on the second audio sequence feature according to the second predetermined decoding parameter information, so as to obtain a recognition result for the second audio sequence feature. It may be determined whether the second audio sequence feature 4103 meets the recognition end condition or not by various methods. As shown in FIG. 4C, the peak sub-information 4403 may indicate that the second audio sequence feature 4103 corresponds to one peak. The decoding operation may be performed once on the second audio sequence feature. In an example, the second predetermined decoding parameter information may include a sentence postfix required by the decoding unit. It may be understood that whether the audio sequence feature meets the recognition start condition or the recognition end condition may be determined based on various methods, which is not limited in the present disclosure.

For another example, a 1^{st} decoding operation may be performed on the 3^{rd} processed audio sequence encoding feature according to the second predetermined decoding parameter information, so as to obtain the 1^{st} recognition sub-result (for example, a Chinese character) for the second audio sequence feature 4103.

After the decoding operation is performed once, the 1^{st} recognition sub-result for the second audio sequence feature 4103 may be used as the recognition result for the second audio sequence feature.

It may be understood that some methods of encoding and decoding the second audio sequence feature have been described in detail above with reference to FIG. 4C. Some methods of determining the historical sub-feature of the second audio sequence feature will be described in detail below with reference to FIG. 4C.

For example, as shown in FIG. 4C, a 1^{st} historical sub-feature h4 of the second audio sequence feature 4103 may be obtained by encoding according to the 1^{st} recognition sub-result for the second audio sequence feature 4103 and the 3^{rd} initial audio sequence encoding feature 42113.

For example, as shown in FIG. 4C, the 1^{st} historical sub-feature h1 of the 1^{st} first audio sequence feature 4101, the 2^{nd} historical sub-feature h2 of the 1^{st} first audio sequence feature 4101, the 1^{st} historical sub-feature h3 of the 2^{nd} first audio sequence feature 4102 and the 1^{st} historical sub-feature h4 of the second audio sequence feature 4103 may be fused to obtain a historical feature corresponding to a target object providing the target audio data.

It may be understood that as shown in FIG. 4A to FIG. 4C, K may be 2, and a value of k may be 1 or 2.

It may be understood that in some other embodiments, after it is determined that the second audio sequence feature 4103 is truncated from the first audio feature, the recognition result for the second audio sequence feature 4103 may not be encoded based on the historical attention mechanism.

It may be understood that some implementations of encoding and decoding the first audio sequence feature and the second audio sequence feature have been described in detail above with reference to FIG. 4A to FIG. 4C. Different decoding methods are used for the two, so that the recognition accuracy of the audio recognition may be further improved. In some other embodiments of the present disclosure, the second audio sequence feature may also be used as the first audio feature, which is not limited in the present disclosure.

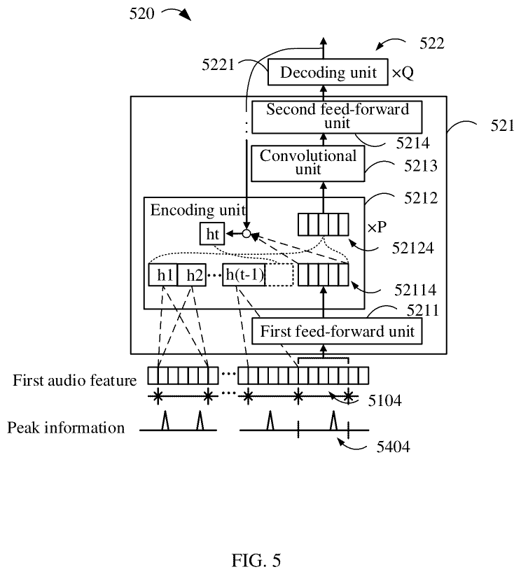

It may be understood that the streaming multi-layer truncated attention sub-model provided in the present disclosure has been described in detail above with K=2 as an example. However, the present disclosure is not limited thereto, and a detailed description will be given below with reference to FIG. 5.

FIG. 5 shows a schematic diagram of a streaming multi-layer truncated attention sub-model according to another embodiment of the present disclosure.

As shown in FIG. 5, a streaming multi-layer truncated attention sub-model 520 may include an encoding network 521 and a decoding network 522. The encoding network 521 may include a first feed-forward unit 5211, P encoding units 5212, a convolutional unit 5213, and a second feed-forward unit 5214. The decoding network 522 may include Q decoding units 5221. Q is an integer greater than or equal to 1. P is an integer greater than or equal to 1.

After k predetermined durations (for example, k seconds) of target audio data are acquired, the first audio feature of the target audio data may be truncated to obtain a k^{th} first audio sequence feature 5104. As shown in FIG. 5, k first audio sequence features have a same length. The k first audio sequence features may also correspond to a same duration, which is the predetermined duration.

The k^{th} first audio sequence feature 5104 may be encoded using the first feed-forward unit 5211, so as to obtain a k^{th} initial audio sequence encoding feature 52114.

For example, based on the self-attention mechanism, the encoding unit 5212 may perform encoding according to the k^{th} initial audio sequence encoding feature 52114, the 1^{st} historical sub-feature h1 of the 1^{st} first audio sequence feature, the 2^{nd} historical sub-feature h2 of the 1^{st} first audio sequence feature, . . . , and a 1^{st} historical sub-feature h(t−1) of a (k−1)^{th} audio sequence feature, so as to obtain a k^{th} target audio sequence encoding feature 52124. It may be understood that t is an integer greater than 1. It may be understood that as shown in FIG. 5, the 1^{st} first audio sequence feature corresponds to two peaks. If the 2^{nd} first audio sequence feature to the (k−1)^{th} first audio sequence feature all correspond to one peak, then k=t−1 in such embodiments.

Then, a convolution may be performed on the k^{th} target audio sequence encoding feature 52124 by using the convolutional unit 5213, so as to obtain a k^{th} convoluted audio sequence encoding feature. The k^{th} convoluted audio sequence encoding feature may be processed using the second feed-forward unit 5214 to obtain a k^{th} processed audio sequence encoding feature.

For another example, after k predetermined durations (for example, k seconds) of target audio data are acquired, a peak sub-information 5404 corresponding to the k^{th} first audio sequence feature 5104 may be determined from the peak information output by the connectionist temporal classification sub-model. As shown in FIG. 5, the peak sub-information 5404 may indicate that the k^{th} first audio sequence feature 5104 corresponds to one peak. It may be understood that I may be 1 for the k^{th} first audio sequence feature 5104.

For another example, an I^{th} decoding parameter information of a (k−1)^{th} first audio sequence feature may be used as the initial decoding parameter information of the k^{th} first audio sequence feature. Then, a 1^{st} decoding operation may be performed on the k^{th} processed audio sequence encoding feature, so as to obtain a 1^{st} decoding parameter information of the k^{th} first audio sequence feature 5104 and also obtain a 1^{st} recognition sub-result (for example, a Chinese character) for the 1^{st} first audio sequence feature 5104.

After the decoding operation is performed once, the 1^{st} recognition sub-result for the k^{th} first audio sequence feature 5104 may be used as a k^{th} recognition result.

It may be understood that some methods of encoding and decoding the k^{th} first audio sequence feature have been described in detail above with reference to FIG. 5. Some methods of determining I historical sub-features of the k^{th} first audio sequence feature will be described in detail below with reference to FIG. 5.

For example, as shown in FIG. 5, encoding may be performed in various manners according to the 1^{st} recognition sub-result for the k^{th} first audio sequence feature 5104 and the k^{th} initial audio sequence encoding feature 52114, so as to obtain a 1^{st} historical sub-feature ht of the k^{th} first audio sequence feature 5104.

In embodiments of the present disclosure, performing at least one decoding operation on the first audio sequence feature may further include: in a case that k is greater than 1 and less than K, fusing the I historical sub-features of the k^{th} first audio sequence feature and the historical feature related to the k^{th} first audio sequence feature to obtain a historical feature related to a (k+1)^{th} first audio sequence feature. For example, as shown in FIG. 5, in a case that k is greater than 1 and less than K, the 1^{st} historical sub-feature h1 of the 1^{st} first audio sequence feature, the 2^{nd} historical sub-feature h2 of the 1^{st} first audio sequence feature, . . . , the 1^{st} historical sub-feature h(t−1) of the (k−1)^{th} first audio sequence feature and the 1^{st} historical sub-feature ht of the k^{th} first audio sequence feature 5104 may be fused to obtain the historical feature related to the (k+1)^{th} first audio sequence feature.

It may be understood that P-level encoding may be performed on the k^{th} initial audio sequence encoding feature 52114 by using the P encoding units 5212, so as to obtain the k^{th} target audio sequence encoding feature.

It may be understood that Q-level decoding may be performed on the k^{th} processed audio sequence encoding feature by using the Q decoding units 5221, so as to perform a decoding operation on the k^{th} processed audio sequence encoding feature.

It may be understood that in embodiments of the present disclosure, in a case of k=K, the I^{th} decoding parameter information of the K^{th} first audio sequence feature may be used as the initial decoding parameter information of the second audio sequence feature. At least one decoding operation may be performed on the second audio sequence feature. For example, taking the decoding operation being performed multiple times on the second audio sequence feature as an example, a 1^{st} decoding operation may be performed on the second audio sequence feature according to the I^{th} decoding parameter information of the K^{th} first audio sequence feature, and then the decoding of the second audio sequence feature is stopped after the decoding is performed using the second predetermined decoding parameter. Through embodiments of the present disclosure, the accuracy of audio recognition may be improved, and it may be ensured that the target audio data corresponds to the target text data.

In embodiments of the present disclosure, the above-mentioned encoding network may be built based on the Conformer model, and the above-mentioned decoding network may be built based on the Transformer model. Through embodiments of the present disclosure, by building the encoding network and the decoding network respectively based on the Conformer model and the Transformer model, the characteristics of the autocorrelation modeling method, that is, being suitable for large-scale data parallel computing, may be fully utilized, which helps to further improve the recognition accuracy of the audio recognition method.

It may be understood that the streaming multi-layer truncated attention sub-model in the present disclosure has been described in detail above. Some implementations of obtaining the peak information of the audio feature will be described in detail below in conjunction with related embodiments.

It may be understood that the peak information of the audio feature may be obtained using the connectionist temporal classification sub-model 340.

As described above, different peaks may correspond to different values. In some embodiments, the connectionist temporal classification sub-model may be a multi-valued connectionist temporal classification sub-model. The multi-valued connectionist temporal classification sub-model may output first text data for the target audio data. The first text data may include at least one first recognition result. Each first recognition result corresponds to a word, a phone, a syllable, or a word piece. For example, taking the first recognition result corresponding to a Chinese character as an example, the multi-valued connectionist temporal classification sub-model may determine a Chinese character corresponding to an audio sub-feature of the second audio feature. The Chinese character comes from over 3000 Chinese characters. When training the multi-valued connectionist temporal classification sub-model, sample audio and labels corresponding to over 3000 Chinese characters are required, resulting in a high training cost. In addition, the multi-valued connectionist temporal classification sub-model has a large quantity of parameters, and a high time cost is required to determine the peak information, so that the peak information may not be output in a timely manner, and a “peak delay” is prone to occur, which further causes the streaming multi-layer truncated attention sub-model to fail to decode the final target text data in a timely manner, and thus affects the user experience.

In addition, the multi-valued connectionist temporal classification sub-model has a large quantity of parameters and also a large computing error. The multi-valued connectionist temporal classification sub-model may not make full use of a context feature of the audio data, and may output inaccurate peak information, so that the streaming multi-layer truncated attention sub-model may not decode accurately and may not output accurate target text data, which further affects the user experience.

It may be understood that in order to improve the user experience, the multi-valued connectionist temporal classification sub-model may be fully trained and optimized using a larger-scale training data set, so as to improve the accuracy of the peak information.

It may also be understood that, as described above, the multi-valued connectionist temporal classification sub-model may not make full use of the context feature of the audio data, and the first text data output by the multi-valued connectionist temporal classification sub-model may be inaccurate. Therefore, a re-decoding may be performed by the streaming multi-layer truncated attention sub-model to improve an overall accuracy of audio recognition.

In order to improve the efficiency of audio recognition and further obtain accurate target text data, in embodiments of the present disclosure, different peaks may correspond to identical values. A detailed description will be given below in conjunction with related embodiments.

In some embodiments, obtaining the peak sub-information corresponding to the first audio sequence feature according to the peak information of the audio feature may include: obtaining the peak information of the audio feature according to the audio feature; and obtaining the peak sub-information corresponding to the first audio sequence feature according to the peak information and the first audio sequence feature.

In embodiments of the present disclosure, the peak information is used to indicate a peak corresponding to the audio feature, and the peak corresponds to a predetermined value. For example, the predetermined value may be 1.

In embodiments of the present disclosure, the predetermined value is used to indicate that the peak corresponds to a semantic unit, and different peaks correspond to a same predetermined value. For example, the semantic unit may be a word, a phone, a syllable or a word piece, etc. For another example, the predetermined values corresponding to different peaks may all be 1.

In embodiments of the present disclosure, the connectionist temporal classification sub-model may be a binary connectionist temporal classification sub-model. The binary connectionist temporal classification sub-model may determine whether an audio sub-feature corresponds to a semantic unit or not. For example, taking the semantic unit being a Chinese character as an example, the binary connectionist temporal classification sub-model may determine whether one or more audio sub-features correspond to a complete Chinese character. If it is determined that one or more audio sub-features correspond to a complete Chinese character, a predetermined value (for example, 1) is output to generate a peak. If it is determined that one or more audio sub-features do not correspond to a complete Chinese character, another predetermined value (for example, 0) is output without generating a peak.

Through embodiments of the present disclosure, the peak information is obtained by using the binary connectionist temporal classification sub-model. The peak information may be quickly determined, and the time cost may be greatly reduced, which helps to output the peak information in a timely manner, and alleviate or even eliminate the “peak delay”, so that the streaming multi-layer truncated attention sub-model may decode the final target text data in a timely manner, and the user experience may be improved.

In addition, through embodiments of the present disclosure, it may be determined whether one or more audio sub-features correspond to a complete Chinese character or not by the binary connectionist temporal classification sub-model with a small quantity of parameters and a small computing error, and an accurate peak information may be output, so that the streaming multi-layer truncated attention sub-model may perform decoding accurately and output accurate target text data, and the user experience may be further improved.

In addition, sample audio and labels are required when training the binary connectionist temporal classification sub-model. Due to few categories of labels, the training cost is not high. Using the binary connectionist temporal classification sub-model may reduce an execution overhead and improve the accuracy of audio recognition.

The binary connectionist temporal classification sub-model in the present disclosure will be described in detail below in conjunction with related embodiments.

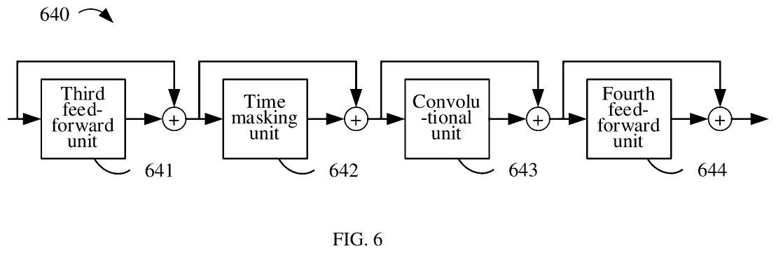

In some embodiments, the connectionist temporal classification sub-model may include a plurality of classification networks. The classification network may include a time masking unit and a convolutional unit. A detailed description will be given below with reference to FIG. 6.

FIG. 6 shows a schematic diagram of a classification network according to an embodiment of the present disclosure.

As shown in FIG. 6, the classification network 640 may include a third feed-forward unit 641, a time masking unit 642, a convolutional unit 643, and a fourth feed-forward unit 644.

In embodiments of the present disclosure, the audio feature includes N audio sub-features, and the audio sub-feature corresponds to a time instant, where N is an integer greater than or equal to 1. For example, a duration between an n^{th} time instant and an (n−1)^{th} time instant may be 10 milliseconds.

In embodiments of the present disclosure, obtaining the peak information of the audio feature according to the audio feature may include: performing a masking on the audio feature to obtain a time-masked feature.

For example, the time-masked feature corresponds to a 1^{st} audio sub-feature to an n^{th} audio sub-feature, where n is an integer greater than 1 and less than N.

For example, a second audio feature is input into the third feed-forward unit 641 to obtain a processed second audio feature. The processed second audio feature is fused with the second audio feature to obtain a first fusion feature. The first fusion feature is input into the time masking unit 642 to obtain a time-masked feature. The time-masked feature may correspond to the 1^{st} audio sub-feature to the n^{th} audio sub-feature. The 1^{st} audio sub-feature may correspond to a start time instant at which the target audio data is acquired. The n^{th} audio sub-feature may correspond to the 1^{st} second. It may be understood that the second audio feature further includes audio sub-features corresponding to a plurality of time instants after the 1^{st} second. The time-masked feature obtained by the masking is independent of the audio sub-feature corresponding to an (n+1)^{th} time instant, so that the historical information before the n^{th} time instant may be used in the process of determining the peak information, so as to meet the requirement of the online speech interaction scenario.

For another example, the time masking unit 642 may be a time masking unit based on multi-head self-attention (Time-Masked Multi-Head Self-Attention Module).

In embodiments of the present disclosure, obtaining the peak information of the audio feature according to the audio feature may include: obtaining the peak information corresponding to n time instants according to the time-masked feature. In embodiments of the present disclosure, obtaining the peak information corresponding to n time instants according to the time-masked feature may include: performing a convolution on the time-masked feature to obtain a convoluted time-masked feature; and obtaining the peak information corresponding to the n time instants according to the convoluted time-masked feature.

For example, the time-masked feature may be fused with the first fusion feature to obtain a second fusion feature. The second fusion feature may be input into the convolutional unit 643 to obtain the convoluted time-masked feature. The convoluted time-masked feature is fused with the second fusion feature to obtain a third fusion feature. The third fusion feature is input into the fourth feed-forward unit 644 to obtain a processed time-masked feature. The processed time-masked feature is fused with the third fusion feature to obtain a fourth fusion feature. It may be understood that the fourth fusion feature may be processed using a fully connected layer to obtain the peak information corresponding to the n time instants. In an example, if the n^{th} audio sub-feature corresponds to the 1^{st} second, the peak information corresponding to the n time instants may be used as the peak sub-information corresponding to the 1^{st} first audio sequence feature.

It may be understood that the above-mentioned convolutional unit 643 may be a causal convolutional unit (Causal Convolutional Module). Through embodiments of the present disclosure, based on the time masking and the causal convolution, it is possible to simultaneously pay attention to a global information and a local information of the audio feature, which helps to improve a description ability of the classification network.

It may be understood that the above-mentioned target audio data may include one or more target audio data. A detailed description will be given below.

In some embodiments, the number of target audio data may be multiple, and the number of audio features may be multiple. For example, the number of target audio data is two, and the number of audio features is two.

In some embodiments, performing at least one decoding operation on the first audio sequence feature may include: performing at least one decoding operation in parallel on the first audio sequence features respectively obtained from the plurality of audio features.

For example, when two target audio data are simultaneously acquired, if the audio feature of the 1^{st} target audio data meets a predetermined duration condition, the audio feature of the 1^{st} target audio data may be truncated to obtain a 1^{st} first audio sequence feature of the 1^{st} target audio data. The number of peaks corresponding to the first audio sequence feature is determined as the number of times the decoding operation is performed on the first audio sequence feature. Then, at least one decoding operation may be performed using a computing unit of the graphics processing unit.

For another example, if the audio feature of the 2^{nd} target audio data meets the predetermined duration condition, the audio feature of the 2^{nd} target audio data may be truncated to obtain a 1^{st} audio sequence feature of the 2^{nd} target audio data. The peak sub-information corresponding to the first audio sequence feature is used as the number of times the decoding operation is performed on the first audio sequence feature. Then, at least one decoding operation may be performed using another computing unit of the graphics processing unit.

Through embodiments of the present disclosure, the durations corresponding to the first audio sequence features from the plurality of audio features may all be the predetermined duration. Based on this, after the first audio sequence feature is obtained, a parallel processing may be performed using the graphics processing unit, so that an inference speed and an audio recognition efficiency may be greatly improved.

In some embodiments, the above-mentioned method may further include: performing at least one decoding operation in parallel on the first audio sequence feature and the second audio sequence feature obtained respectively from the plurality of audio features. As described above, the length of the second audio sequence feature may be identical to the length of the first audio sequence feature. For example, if there is a difference between the duration corresponding to the first audio sequence feature and the duration corresponding to the second audio sequence feature, a specific value may be added to the second audio sequence feature, so that the length of the second audio sequence feature is identical to the length of the first audio sequence feature.

In some embodiments, the first audio sequence feature may include J audio sequence sub-features, where J is an integer greater than 1. For example, taking J=5 as an example, the (k−1)^{th} first audio sequence feature may include five audio sequence sub-features.

In some embodiments, the k^{th} first audio sequence feature includes a (J−H)^{th} audio sequence sub-features of the (k−1)^{th} first audio sequence feature, where H is an integer greater than or equal to 0. For example, taking J=5 and H=0 as an example, the k^{th} first audio sequence feature may include a 5^{th} audio sequence sub-feature of the (k−1)^{th} first audio sequence feature. The k^{th} first audio sequence feature may further include the other four audio sequence sub-features. Through embodiments of the present disclosure, there is an overlap between two adjacent first audio sequence features, and a context information may be introduced to improve the encoding ability of the streaming multi-layer truncated attention sub-model.

It may be understood that in a case that there is an overlap between two adjacent first audio sequence features, the peak sub-information corresponding to the (k−1)^{th} first audio sequence feature may be the peak sub-information corresponding to the 1^{st} audio sequence sub-feature to the (J−H)^{th} audio sequence sub-feature of the (k−1)^{th} first audio sequence feature. The peak sub-information corresponding to the k^{th} first audio sequence feature may be the peak sub-information corresponding to the 1^{st} audio sequence sub-feature to the (J−H)^{th} audio sequence sub-feature of the k^{th} first audio sequence feature.

It may be understood that the second audio sequence feature may also include J audio sequence sub-features. The second audio sequence feature may include the (J−H)^{th} audio sequence sub-feature of the K^{th} first audio sequence feature. Through embodiments of the present disclosure, there may also be an overlap between the first audio sequence feature and the second audio sequence feature, and a context information may be introduced to further improve the encoding ability of the streaming multi-layer truncated attention sub-model.

It may be understood that the audio recognition method in the present disclosure has been described in detail above. In order to implement the audio recognition method, an audio recognition model may be trained, which will be described in detail below.

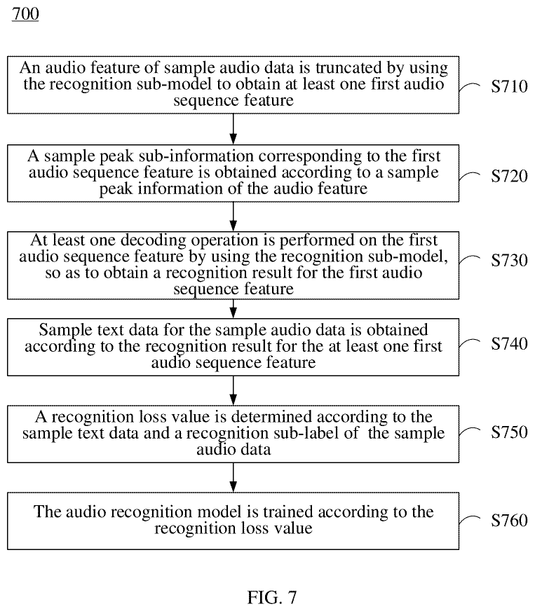

FIG. 7 shows a flowchart of a method of training an audio recognition model according to an embodiment of the present disclosure.

As shown in FIG. 7, a method 700 may include operation S710 to operation S760.

In embodiments of the present disclosure, the audio recognition model includes a recognition sub-model.

In operation S710, an audio feature of sample audio data is truncated by using the recognition sub-model, so as to obtain at least one first audio sequence feature.

In embodiments of the present disclosure, Mel spectrum data of the target audio data may be acquired to obtain the audio feature.

In embodiments of the present disclosure, the sample audio data may correspond to various languages. For example, the sample audio data may correspond to Chinese. For another example, the sample audio data may correspond to English.

In embodiments of the present disclosure, a duration corresponding to the at least one first audio sequence feature is a predetermined duration.

In embodiments of the present disclosure, in a case of a plurality of first audio sequence features, the first audio sequence features may all correspond to the predetermined duration. For example, the duration corresponding to the first audio sequence feature may be 1 second. For another example, the duration corresponding to the first audio sequence feature may be 10 milliseconds.

For another example, the duration corresponding to the audio feature of the sample audio data may be 3 seconds. After the audio feature of the sample audio data is acquired, for example, two first audio sequence features may be obtained by truncating, including a 1^{st} first audio sequence feature and a 2^{nd} first audio sequence feature. The durations corresponding to the two may both be one second. It may be understood that, different from the target audio data, all sample audio data may be acquired directly, and the duration of the sample audio data may be determined. Therefore, it is possible to directly truncate all the first audio sequence features of the sample audio data.

In operation S720, a sample peak sub-information corresponding to the first audio sequence feature is obtained according to a sample peak information of the audio feature.

In embodiments of the present disclosure, the sample peak sub-information is used to indicate the sample peak corresponding to the first audio sequence feature. For example, the sample peak may correspond to a value. In an example, different sample peaks may correspond to different values. In another example, different sample peaks may correspond to identical values.

In embodiments of the present disclosure, the sample peak information may be determined according to the audio feature. Then, the sample peak sub-information corresponding to the first audio sequence feature may be determined according to the sample peak information. For example, the sample peak information is generated according to the audio feature. According to the time period corresponding to the first audio sequence feature, the sample peak sub-information corresponding to the time period may be obtained from the sample peak information. The sample peak sub-information is determined as the sample peak sub-information corresponding to the first audio sequence feature. For another example, the sample peak information may be determined using various methods.

In operation S730, at least one decoding operation is performed on the first audio sequence feature by using a recognition sub-model, so as to obtain a recognition result for the first audio sequence feature.

In embodiments of the present disclosure, the number of times the decoding operation is performed is identical to the number of sample peaks corresponding to the first audio sequence feature. For example, in a case of three sample peaks, the number of decoding operations performed may be three times.

For example, the number of sample peaks corresponding to the 1^{st} first audio sequence feature may be used as the number of times the decoding operation is performed on the 1^{st} first audio sequence feature, so that at least one decoding operation is performed on the 1^{st} first audio sequence feature to obtain a 1^{st} recognition result. For another example, the number of peaks corresponding to the 2^{nd} first audio sequence feature may be used as the number of times the decoding operation is performed on the 2^{nd} first audio sequence feature, so that at least one decoding operation is performed on the 2^{nd} first audio sequence feature to obtain a 2^{nd} recognition result.

In embodiments of the present disclosure, the recognition result may be recognition results in various languages. For example, in a case that the sample audio data corresponds to Chinese, the recognition result may contain at least one Chinese character. For example, in a case that the sample audio data corresponds to English, the recognition result may contain at least one English word or word piece. It may be understood that an English word may be composed of one or more word pieces.

In operation S740, sample text data for the sample audio data is obtained according to the recognition result for the at least one first audio sequence feature.

In embodiments of the present disclosure, the recognition results for the at least one first audio sequence feature may be fused to obtain the sample text data. For example, the 1^{st} recognition result and the 2^{nd} recognition result may be concatenated to obtain the sample text data.

In operation S750, a recognition loss value is determined according to the sample text data and a recognition sub-label of the sample audio data.

In embodiments of the present disclosure, the recognition loss value may be determined using various loss functions.

In operation S760, the audio recognition model is trained according to the recognition loss value.

In embodiments of the present disclosure, a parameter of the recognition sub-model may be adjusted according to the recognition loss value based on a back-propagation algorithm, so as to train the audio recognition model.

Through embodiments of the present disclosure, by truncating the audio feature into the first audio sequence feature having the predetermined length, it is possible to efficiently and quickly obtain the first audio sequence feature and perform subsequent processing, which helps to improve the efficiency of audio recognition. In addition, in a case that the plurality of first audio sequence features have identical lengths, the graphics processing unit may be effectively utilized to perform parallel training, so as to further improve the training efficiency of the audio recognition model.

In addition, through embodiments of the present disclosure, it is not required to overly rely on other information when truncating the audio feature, and the truncation may be performed even if the peak information is not acquired in a timely manner, so that the efficiency of obtaining the first audio sequence feature is improved. Furthermore, a time and overhead of parsing the peak information may be saved, which may further improve the efficiency of obtaining the first audio sequence feature and reduce a resource overhead, so that the trained audio recognition model is more suitable for online speech interaction scenarios.

In addition, through embodiments of the present disclosure, for a first audio sequence feature, the number of times the decoding operation is performed is identical to the number of sample peaks, so that the number of times of decoding the first audio sequence feature may be ensured, and the accuracy of audio recognition may not be reduced. In addition, the decoding may be performed accurately when the number of peaks is accurate, and a requirement for the accuracy of position information of the peaks is reduced. Thus, the first audio sequence feature may be efficiently obtained, the decoding may be efficiently and accurately performed, and the audio recognition accuracy and the computing efficiency may be effectively balanced.

In addition, through embodiments of the present disclosure, at least one decoding operation may be performed using a Conformer model, a Transformer model or other models. Then, the dependence on temporal information may be reduced or eliminated, and the first audio sequence features in different time periods may be directly processed, which may reduce or avoid a gradual transmission of error information along with the temporal information, and improve the accuracy of the model. In addition, the Conformer model or the Transformer model, etc. is more in line with the characteristics of the graphics processing unit, which may help to use parallel computing to accelerate the decoding.

In addition, through embodiments of the present disclosure, the dependency between the recognition sub-model and other sub-models may be reduced, the difficulty of model adjustment and optimization may be reduced, and the efficiency of model update iteration may be improved.

It may be understood that the implementation process of the method provided in the present disclosure has been described above. The principle of the training method provided in the present disclosure will be described in detail below in conjunction with related embodiments.

In some embodiments, the audio recognition model may include a first convolutional sub-model, a recognition sub-model, a second convolutional sub-model, and a classification sub-model. For example, the recognition sub-model may be a streaming multi-layer truncated attention sub-model. For another example, the classification sub-model may be a connectionist temporal classification sub-model. It may be understood that the recognition sub-model may also be other models, and the classification sub-model may also be other models.

In embodiments of the present disclosure, the audio feature may be obtained by performing a feature extraction on the sample audio data.

In embodiments of the present disclosure, truncating the audio feature of the sample audio data by using the recognition sub-model may include: inputting the audio feature into the first convolutional sub-model of the audio recognition model to obtain a first audio feature, and truncating the first audio feature by using the recognition sub-model.

For example, a convolution may be performed on the audio feature by using the first convolutional sub-model, so as to obtain the first audio feature. Then, the first audio feature may be truncated by using the streaming multi-layer truncated attention sub-model to obtain at least one first audio sequence feature. For another example, the first audio feature may be truncated according to a predetermined time interval by using the streaming multi-layer truncated attention sub-model, so as to obtain the 1^{st} first audio sequence feature and the 2^{nd} first audio sequence feature.

In embodiments of the present disclosure, obtaining the sample peak sub-information corresponding to the first audio sequence feature according to the sample peak information of the audio feature may include: inputting the audio feature into the second convolutional sub-model of the audio recognition model to obtain a second audio feature; and obtaining the sample peak sub-information corresponding to the first audio sequence feature according to the sample peak information of the second audio feature.

For example, a convolution may be performed on the audio feature by using the second convolutional sub-model, so as to obtain the second audio feature. Then, the second audio feature may be processed using the connectionist temporal classification sub-model to obtain the sample peak information. The peak information is input into the streaming multi-layer truncated attention sub-model to determine the sample peak sub-information corresponding to the truncated first audio sequence feature. It may be understood that both the first audio feature and the second audio feature are obtained by performing a convolution on the audio feature. The sample peak sub-information corresponding to the first audio sequence feature may be determined based on the time period corresponding to the first audio sequence feature.

In embodiments of the present disclosure, the first convolutional sub-model may include a plurality of stacked convolutional layers. For example, each convolutional layer may perform a convolution down-sampling with a stride of 2. For another example, a frame rate corresponding to the first audio feature may be ¼ of that of the audio feature.

In embodiments of the present disclosure, the second convolutional sub-model may include a plurality of stacked convolutional layers. For example, each convolutional layer may perform a convolution down-sampling with a stride of 2. For another example, the frame rate corresponding to the second audio feature may be ¼ of that of the audio feature.

In embodiments of the present disclosure, the first convolutional sub-model and the second convolutional sub-model may have identical structures. For example, the number of convolutional layers of the first convolutional sub-model may be identical to the number of convolutional layers of the second convolutional sub-model. Through embodiments of the present disclosure, by performing convolution down-sampling on the audio feature, it is possible to effectively obtain a deep information from the audio feature, and improve the performance of the audio recognition model. In addition, as the first convolutional sub-model and the second convolutional sub-model have identical structures, the graphics processing unit may be fully utilized to perform parallel training, so as to further improve the performance of the audio recognition model and improve the model training efficiency.

Then, at least one decoding operation may be performed on the first audio sequence feature by using the decoding network of the streaming multi-layer truncated attention sub-model, so as to obtain the recognition result. For example, at least one decoding operation may be performed on the 1^{st} first audio sequence feature by using the decoding network of the streaming multi-layer truncated attention sub-model, so as to obtain the 1^{st} recognition result. For another example, at least one decoding operation may be performed on the 2^{nd} first audio sequence feature by using the decoding network of the streaming multi-layer truncated attention sub-model, so as to obtain the 2^{nd} recognition result. The sample text data may be obtained according to the two recognition results.

In embodiments of the present disclosure, the recognition sub-label is used to indicate the text data corresponding to the sample audio data. For example, the recognition sub-label may indicate real text data corresponding to the sample audio data. In embodiments of the present disclosure, the recognition loss value is determined according to the sample text data and the recognition sub-label of the sample audio data. For example, the recognition loss value may be determined using a cross-entropy loss function according to the sample text data and the recognition sub-label.

In embodiments of the present disclosure, training the audio recognition model according to the recognition loss value may include: determining a classification loss value according to the sample peak information and the classification sub-label of the sample audio data. For example, the classification sub-label is used to indicate a real peak corresponding to the sample audio data, and the real peak corresponds to a semantic unit. For example, as described above, the second audio feature may be processed using the connectionist temporal classification sub-model to obtain the sample peak information. The classification loss value may be determined by using a Connectionist Temporal Classification Loss (CTC Loss) function according to the sample peak information and the classification sub-label.

Then, the audio recognition model may be trained according to the classification loss value and the recognition loss value. For example, a parameter of the connectionist temporal classification sub-model may be adjusted according to the classification loss value, so as to train the classification sub-model of the audio recognition model. A parameter of the streaming multi-layer truncated attention sub-model may also be adjusted according to the recognition loss value, so as to train the recognition sub-model of the audio recognition model. After multiple adjustments, a trained audio recognition model may be obtained to perform an online speech interaction.

In some embodiments, truncating the first audio feature may include: in response to a determination that the duration corresponding to the first audio feature meets a predetermined duration condition, truncating the first audio feature by using the recognition sub-model.

It may be understood that the principle of the method of training the audio recognition model in the present disclosure has been described in detail above. The recognition sub-model of the present disclosure will be described in detail below in conjunction with related embodiments. For example, the recognition sub-model may be a streaming multi-layer truncated attention sub-model.

In some embodiments, the number of first audio sequence features is K, a recognition result for a k^{th} first audio sequence feature among K first audio sequence features includes I recognition sub-results, and the k^{th} first audio sequence feature corresponds to I sample peaks. I is an integer greater than or equal to 1, k is an integer greater than or equal to 1 and less than K, and K is an integer greater than 1. A detailed description will be given below in conjunction with related embodiments.

The streaming multi-layer truncated attention sub-model may include an encoding network and a decoding network. The encoding network may include a first feed-forward unit, P encoding units, a convolutional unit, and a second feed-forward unit. The decoding network may include Q decoding units. Q is an integer greater than or equal to 1. P is an integer greater than or equal to 1.

In embodiments of the present disclosure, performing at least one decoding operation on the first audio sequence feature by using the recognition sub-model may include: encoding the k^{th} first audio sequence feature by using the first feed-forward unit of the encoding network, so as to obtain a k^{th} initial audio sequence encoding feature; and processing the k^{th} initial audio sequence encoding feature by using the encoding unit of the encoding network, so as to obtain a k^{th} target audio sequence encoding feature.

For example, the 1^{st} first audio sequence feature may be encoded using the first feed-forward unit, so as to obtain a 1^{st} initial audio sequence encoding feature. Then, based on the self-attention mechanism, the encoding unit may encode the 1^{st} initial audio sequence encoding feature to obtain a 1^{st} target audio sequence encoding feature.

Then, a convolution may be performed on the 1^{st} target audio sequence encoding feature by using the convolutional unit, so as to obtain a 1^{st} convoluted audio sequence encoding feature. The 1^{st} convoluted audio sequence encoding feature may be processed using the second feed-forward unit, so as to obtain a 1^{st} processed audio sequence encoding feature.

For another example, the sample peak sub-information corresponding to the 1^{st} first audio sequence feature may be determined from the sample peak information output by the connectionist temporal classification sub-model. The sample peak sub-information may indicate that the 1^{st} first audio sequence feature corresponds to two sample peaks.

In embodiments of the present disclosure, performing at least one decoding operation on the first audio sequence feature by using the recognition sub-model may include: in response to a determination that the first audio sequence feature meets a recognition start condition, performing at least one decoding operation on the first audio sequence feature by using the decoding network according to a first predetermined decoding parameter information, so as to obtain an original decoding parameter information and a recognition result.

For example, the recognition start condition may refer to that the first audio sequence feature is a 1^{st} audio sequence feature truncated from the audio feature. It may be determined whether the 1^{st} first audio sequence feature meets the recognition start condition or not using various methods. I decoding operations may be performed on the 1^{st} first audio sequence feature according to the first predetermined decoding parameter information, so as to obtain the original decoding parameter information and I recognition sub-results. In an example, the first predetermined decoding parameter information may include a sentence prefix of the decoding unit. As described above, the sample peak sub-information corresponding to the 1^{st} first audio sequence feature may indicate that the 1^{st} first audio sequence feature corresponds to two sample peaks. It may be understood that I may be 2 for the 1^{st} first audio sequence feature.

In embodiments of the present disclosure, performing at least one decoding operation on the first audio sequence feature by using the recognition sub-model may include: performing a 1^{st} decoding operation on the k^{th} first audio sequence feature by using the decoding network according to the initial decoding parameter information of the k^{th} first audio sequence feature, so as to obtain a 1^{st} decoding parameter information of the k^{th} first audio sequence feature and a 1^{st} recognition sub-result for the k^{th} first audio sequence feature. For example, the first predetermined decoding parameter information may be used as the initial decoding parameter information of the 1^{st} first audio sequence feature. Then, a 1^{st} decoding operation is performed on a 1^{st} processed audio sequence encoding feature, so as to obtain a 1^{st} decoding parameter information of the 1^{st} first audio sequence feature, and also obtain a 1^{st} recognition sub-result for the 1^{st} first audio sequence feature. In an example, the 1^{st} recognition sub-result may be a Chinese character. For example, Q-level decoding may be performed on the 1^{st} processed audio sequence encoding feature by using the Q decoding units, so as to implement a decoding operation.

In embodiments of the present disclosure, performing at least one decoding operation on the first audio sequence feature by using the recognition sub-model may include: performing an i^{th} decoding operation on the k^{th} first audio sequence feature by using the decoding network according to an (i−1)^{th} decoding parameter information of the k^{th} first audio sequence feature, so as to obtain an i^{th} decoding parameter information of the k^{th} first audio sequence feature and an i^{th} recognition sub-result for the k^{th} first audio sequence feature. In addition, in embodiments of the present disclosure, performing the i^{th} decoding operation on the k^{th} first audio sequence feature by using the decoding network includes: performing an I^{th} decoding operation on the k^{th} first audio sequence feature by using the decoding network according to an (I−1)^{th} decoding parameter information of the k^{th} first audio sequence feature, so as to obtains an I^{th} decoding parameter information of the k^{th} first audio sequence feature and an I^{th} recognition sub-result for the k^{th} first audio sequence feature.

For example, i is an integer greater than 1 and less than or equal to I. For another example, as mentioned above, I may be 2 for the 1^{st} first audio sequence feature. In a case of i=I=2, a 2^{nd} decoding operation may be performed on the 1^{st} processed audio sequence encoding feature according to the 1^{st} decoding parameter information of the 1^{st} first audio sequence feature, so as to obtain a 2^{nd} decoding parameter information of the 1^{st} first audio sequence feature and also obtain a 2^{nd} recognition sub-result for the 1^{st} first audio sequence feature. In an example, the 2^{nd} recognition sub-result may also be a Chinese character.

After two decoding operations are performed, the 1^{st} recognition sub-result and the 2^{nd} recognition sub-result for the 1^{st} first audio sequence feature may be used as the recognition result for the 1^{st} first audio sequence feature.

It may be understood that some methods of encoding and decoding the 1^{st} first audio sequence feature have been described in detail above. After the recognition result is obtained, the streaming multi-layer truncated attention sub-model may further determine a historical feature, so as to encode the 2^{nd} first audio sequence feature based on a historical attention mechanism. A detailed description will be given below.

In embodiments of the present disclosure, performing at least one decoding operation on the first audio sequence feature by using the recognition sub-model may include: obtaining a 1^{st} historical sub-feature of the k^{th} first audio sequence feature according to the 1^{st} recognition sub-result for the k^{th} first audio sequence feature and the k^{th} initial audio sequence encoding feature. For example, the encoding unit may perform encoding according to the 1^{st} recognition sub-result for the 1^{st} first audio sequence feature and the 1^{st} initial audio sequence encoding feature, so as to obtain the 1^{st} historical sub-feature of the 1^{st} first audio sequence feature.

In embodiments of the present disclosure, performing at least one decoding operation on the first audio sequence feature by using the recognition sub-model may further include: obtaining an i^{th} historical sub-feature of the k^{th} first audio sequence feature according to the i^{th} recognition sub-result for the k^{th} first audio sequence feature and the k^{th} initial audio sequence feature. For example, in a case of i=I=2, the encoding unit may perform encoding according to the 2^{nd} recognition sub-result for the 1^{st} first audio sequence feature and the 1^{st} initial audio sequence feature, so as to obtain a 2^{nd} historical sub-feature of the 1^{st} first audio sequence feature.

In embodiments of the present disclosure, performing at least one decoding operation on the first audio sequence feature by using the recognition sub-model may further include: in a case of k=1, fusing I historical sub-features of the k^{th} first audio sequence feature to obtain a historical feature related to a (k+1)^{th} first audio sequence feature. For example, the 1^{st} historical sub-feature of the 1^{st} first audio sequence feature and the 2^{nd} historical sub-feature of the 1^{st} first audio sequence feature may be concatenated to obtain a historical feature related to the 2^{nd} first audio sequence feature.

In addition, in embodiments of the present disclosure, performing at least one decoding operation on the k^{th} first audio sequence feature by using the decoding network may further include: when k is less than K, using the I^{th} decoding parameter information of the k^{th} first audio sequence feature as the initial decoding parameter information of the (k+1)^{th} first audio sequence feature. For example, the 2^{nd} decoding parameter information of the 1^{st} first audio sequence feature may be used as the initial decoding parameter information of the 2^{nd} first audio sequence feature.

It may be understood that some methods of encoding and decoding the 1^{st} first audio sequence feature and some methods of processing the recognition result for the 1^{st} first audio sequence feature based on the historical attention mechanism have been described above in detail. Some methods of encoding and decoding the 2^{nd} first audio sequence feature will be described in detail below in conjunction with related embodiments.

For example, the 1^{st} first audio sequence feature and the 2^{nd} first audio sequence feature may correspond to the same duration, which is the predetermined duration. In an example, the duration corresponding to the 1^{st} first audio sequence feature and the duration corresponding to the 2^{nd} first audio sequence feature are both one second. In the training stage, the 1^{st} first audio sequence feature and the 2^{nd} first audio sequence feature may be obtained simultaneously.

The 2^{nd} first audio sequence feature may be encoded using the first feed-forward unit, so as to obtain a 2^{nd} initial audio sequence encoding feature.

In embodiments of the present disclosure, processing the k^{th} initial audio sequence encoding feature by using the encoding unit of the encoding network to obtain the k^{th} target audio sequence encoding feature may include: processing the historical feature related to the k^{th} first audio sequence feature and the k^{th} initial audio sequence encoding feature by using the encoding unit, so as to obtain the k^{th} target audio sequence encoding feature. For example, based on the self-attention mechanism, the encoding unit may perform encoding according to the 2^{nd} initial audio sequence encoding feature, the 1^{st} historical sub-feature h1 of the 1^{st} first audio sequence feature and the 2^{nd} historical sub-feature of the 1^{st} first audio sequence feature, so as to obtain a 2^{nd} target audio sequence encoding feature.

Then, a convolution may be performed on the 2^{nd} target audio sequence encoding feature by using the convolutional unit, so as to obtain a 2^{nd} convoluted audio sequence encoding feature. The 2^{nd} convoluted audio sequence encoding feature may be processed using the second feed-forward unit, so as to obtain a 2^{nd} processed audio sequence encoding feature.

For another example, a sample peak sub-information corresponding to the 2^{nd} first audio sequence feature may be determined from the sample peak information output by the connectionist temporal classification sub-model. The sample peak sub-information may indicate that the 2^{nd} first audio sequence feature corresponds to one sample peak. It may be understood that I may be 1 for the 2^{nd} first audio sequence feature.

For another example, as described above, the 2^{nd} decoding parameter information of the 1^{st} first audio sequence feature is used as the initial decoding parameter information of the 2^{nd} first audio sequence feature. Then, a 1^{st} decoding operation is performed on the 2^{nd} processed audio sequence encoding feature, so as to obtain a 1^{st} decoding parameter information of the 2^{nd} first audio sequence feature and also obtain a 1^{st} recognition sub-result (for example, a Chinese character) for the 1^{st} first audio sequence feature.

After the decoding operation is performed once, the 1^{st} recognition sub-result for the 2^{nd} first audio sequence feature may be used as the recognition result for the 2^{nd} first audio sequence feature.

It may be understood that some methods of encoding and decoding the first audio sequence feature have been described in detail above. Some methods of determining I historical sub-features of the 2^{nd} first audio sequence feature will be described in detail below.

For example, the encoding unit may perform encoding according to the 1^{st} recognition sub-result for the 2^{nd} first audio sequence feature and the 2^{nd} initial audio sequence encoding feature, so as to obtain a 1^{st} historical sub-feature of the 2^{nd} first audio sequence feature.

In embodiments of the present disclosure, performing at least one decoding operation on the first audio sequence feature may further include: in a case of k=K, fusing the I historical sub-features of the K^{th} first audio sequence feature and the historical feature related to the K^{th} first audio sequence feature to obtain a historical feature related to a next audio sequence feature. For example, the 1^{st} historical sub-feature of the 1^{st} first audio sequence feature, the 2^{nd} historical sub-feature of the 1^{st} first audio sequence feature and the 1^{st} historical sub-feature of the 2^{nd} first audio sequence feature may be concatenated to obtain the historical feature related to the next audio sequence feature.

It may be understood that some methods of encoding and decoding the 2^{nd} first audio sequence feature and some methods of processing the recognition result for the 2^{nd} first audio sequence feature based on the historical attention mechanism are described above in detail. Some methods of encoding and decoding the second audio sequence feature will be described in detail below in conjunction with related embodiments.

The first audio feature may be truncated to obtain three audio sequence features. These three audio sequence features may include the 1^{st} first audio sequence feature and the 2^{nd} first audio sequence feature mentioned above. For a last audio sequence feature, if it is determined that the last audio sequence feature meets the recognition end condition, it may be determined that a second audio sequence feature is truncated from the first audio feature. The last audio sequence feature is used as the second audio sequence feature. For example, the recognition end condition may refer to that the audio sequence feature is the last audio sequence feature of the audio feature.

The 1^{st} first audio sequence feature, the 2^{nd} first audio sequence feature and the second audio sequence feature may correspond to a same duration. In an example, the duration corresponding to the 1^{st} first audio sequence feature, the duration corresponding to the 2^{nd} first audio sequence feature, and the duration corresponding to the second audio sequence feature are all one second. In the training stage, the 1^{st} first audio sequence feature, the 2^{nd} first audio sequence feature and the second audio sequence feature may be obtained simultaneously.

The second audio sequence feature may be encoded using the first feed-forward unit to obtain a 3^{rd} initial audio sequence encoding feature.

For example, based on the self-attention mechanism, the encoding unit may perform encoding according to the 3^{rd} initial audio sequence encoding feature, the 1^{st} historical sub-feature of the 1^{st} first audio sequence feature, the 2^{nd} historical sub-feature of the 1^{st} first audio sequence feature and the 1^{st} historical sub-feature of the 2^{nd} first audio sequence feature, so as to obtain the 3^{rd} target audio sequence encoding feature.

Then, a convolution may be performed on the 3^{rd} target audio sequence encoding feature by using the convolutional unit, so as to obtain a 3^{rd} convoluted audio sequence encoding feature. The 3^{rd} convoluted audio sequence encoding feature may be processed using the second feed-forward unit, so as to obtain a 3^{rd} processed audio sequence encoding feature.

For another example, a sample peak sub-information corresponding to the second audio sequence feature may be determined from the sample peak information output by the connectionist temporal classification sub-model. The sample peak sub-information may indicate that the second audio sequence feature corresponds to one sample peak. It may be understood that for the second audio sequence feature, the number of times the decoding operation is performed is less than or equal to the number of peaks corresponding to the second audio sequence feature.

In embodiments of the present disclosure, obtaining the sample text data for the sample audio data according to the recognition result for the at least one first audio sequence feature may include: in response to a determination that the second audio sequence feature is truncated from the audio feature, performing at least one decoding operation on the second audio sequence feature by using the decoding network according to a second predetermined decoding parameter information, so as to obtain a recognition result for the second audio sequence feature. It may be determined whether the second audio sequence feature meets the recognition end condition or not using various methods. The sample peak sub-information corresponding to the second audio sequence feature may indicate that the second audio sequence feature corresponds to one sample peak. The decoding operation is performed once on the second audio sequence feature. In an example, the second predetermined decoding parameter information may include a sentence postfix of the decoding unit. It may be understood that whether the audio sequence feature meets the recognition start condition or the recognition end condition may be determined based on various methods, which is not limited in the present disclosure.

For another example, a 1^{st} decoding operation may be performed on the 3^{rd} processed audio sequence encoding feature according to the second predetermined decoding parameter information, so as to obtain a 1^{st} recognition sub-result (for example, a Chinese character) of the second audio sequence feature.

After the decoding operation is performed once, the 1^{st} recognition sub-result for the second audio sequence feature may be used as the recognition result for the second audio sequence feature.

It may be understood that some methods of encoding and decoding the second audio sequence feature have been described in detail above. Some methods of determining the historical sub-feature of the second audio sequence feature will be described in detail below.

For example, the encoding unit may perform encoding according to the 1^{st} recognition sub-result for the second audio sequence feature and the 3^{rd} initial audio sequence encoding feature, so as to obtain a 1^{st} historical sub-feature of the second audio sequence feature.

For example, the 1^{st} historical sub-feature of the 1^{st} first audio sequence feature, the 2^{nd} historical sub-feature of the 1^{st} first audio sequence feature, the 1^{st} historical sub-feature of the 2^{nd} first audio sequence feature and the 1^{st} historical sub-feature of the second audio sequence feature may be fused to obtain a historical feature corresponding to a sample object providing the sample audio data.

It may be understood that in such embodiments, K may be 2, and a value of k may be 1 or 2.

It may be understood that in some other embodiments, after the second audio sequence feature is truncated from the first audio feature, the recognition result for the second audio sequence feature may not be encoded based on the historical attention mechanism.

It may be understood that some implementations of encoding and decoding the first audio sequence feature and the second audio sequence feature have been described in detail above, and different decoding methods are used for the two, which may further improve the recognition accuracy of the audio recognition model. In some other embodiments of the present disclosure, the second audio sequence feature may also be used as a first audio feature.

It may be understood that the streaming multi-layer truncated attention sub-model provided in the present disclosure is described in detail above with K=2 as an example. However, the present disclosure is not limited thereto, and a detailed description will be given below in conjunction with related embodiments.

The first audio feature of the sample audio data may be truncated K times to obtain K first audio sequence features. The K first audio sequence features have a same length. The K first audio sequence features may also correspond to a same duration, which is the predetermined duration.

The k^{th} first audio sequence feature may be encoded using the first feed-forward unit to obtain a k^{th} initial audio sequence encoding feature. The 1^{st} first audio sequence feature may correspond to two peaks, and the 2^{nd} first audio sequence feature to the (k−1)^{th} first audio sequence feature may all correspond to one peak.

For example, based on the self-attention mechanism, the encoding unit may perform encoding according to the k^{th} initial audio sequence encoding feature, the 1^{st} historical sub-feature of the 1^{st} first audio sequence feature, the 2^{nd} historical sub-feature of the 1^{st} first audio sequence feature, . . . , the 1^{st} historical sub-feature of the (k−1)^{th} audio sequence feature, so as to obtain a k^{th} target audio sequence encoding feature.

Then, a convolution may be performed on the k^{th} target audio sequence encoding feature by using the convolutional unit, so as to obtain a k^{th} convoluted audio sequence encoding feature. The k^{th} convoluted audio sequence encoding feature may be processed using the second feed-forward unit to obtain a k^{th} processed audio sequence encoding feature.

For another example, a sample peak sub-information corresponding to the k^{th} first audio sequence feature may be determined from the peak information output by the connectionist temporal classification sub-model. The sample peak sub-information may indicate that the k^{th} first audio sequence feature corresponds to one sample peak. It may be understood that I may be 1 for the k^{th} first audio sequence feature.

For another example, the I^{th} decoding parameter information of the (k−1)^{th} first audio sequence feature may be used as the initial decoding parameter information of the k^{th} first audio sequence feature. Then, a 1^{st} decoding operation may be performed on the k^{th} processed audio sequence encoding feature by using the decoding network, so as to obtain the 1^{st} decoding parameter information of the k^{th} first audio sequence feature and also obtain the 1^{st} recognition sub-result (for example, a Chinese character) for the 1^{st} first audio sequence feature.

After the decoding operation is performed once, the 1^{st} recognition sub-result for the k^{th} first audio sequence feature may be used as a k^{th} recognition result.

It may be understood that some methods of encoding and decoding the k^{th} first audio sequence feature have been described in detail above. Some methods of determining the I historical sub-features of the k^{th} first audio sequence feature will be described in detail below.

For example, the encoding unit may perform encoding according to the 1^{st} recognition sub-result for the k^{th} first audio sequence feature and the k^{th} initial audio sequence encoding feature, so as to obtain a 1^{st} historical sub-feature of the k^{th} first audio sequence feature.

In embodiments of the present disclosure, performing at least one decoding operation on the first audio sequence feature may further include: when k is greater than 1 and less than K, fusing the I historical sub-features of the k^{th} first audio sequence feature and the historical feature related to the k^{th} first audio sequence feature to obtain a historical feature related to the (k+1)^{th} first audio sequence feature. For example, when k is greater than 1 and less than K, the 1^{st} historical sub-feature of the 1^{st} first audio sequence feature, the 2^{nd} historical sub-feature of the 1^{st} first audio sequence feature, . . . , the 1^{st} historical sub-feature of the (k−1)^{th} first audio sequence feature and the 1^{st} historical sub-feature of the k^{th} first audio sequence feature may be fused to obtain the historical feature related to the (k+1)^{th} first audio sequence feature.

It may be understood that P-level encoding may be performed on the k^{th} initial audio sequence encoding feature by using the P encoding units, so as to obtain the k^{th} target audio sequence encoding feature.

It may be understood that Q-level decoding may be performed on the k^{th} processed audio sequence encoding feature by using the Q decoding units, so as to perform a decoding operation on the k^{th} processed audio sequence encoding feature.

It may be understood that in embodiments of the present disclosure, in a case of k=K, the I^{th} decoding parameter information of the K^{th} first audio sequence feature may be used as the initial decoding parameter information of the second audio sequence feature. At least one decoding operation may be performed on the second audio sequence feature. For example, taking the decoding operation being performed multiple times on the second audio sequence feature as an example, a 1^{st} decoding operation may be performed on the second audio sequence feature according to the I^{th} decoding parameter information of the K^{th} first audio sequence feature. Then, the decoding of the second audio sequence feature is stopped after the decoding is performed using the second predetermined decoding parameter. Through embodiments of the present disclosure, the accuracy of audio recognition may be improved.

In embodiments of the present disclosure, the above-mentioned encoding network may be built based on the Conformer model, and the above-mentioned decoding network may be built based on the Transformer model. Through embodiments of the present disclosure, by building the encoding network and the decoding network respectively based on the Conformer model and the Transformer model, the characteristics of the autocorrelation modeling method, that is, being suitable for large-scale data parallel computing and training, may be fully utilized, which helps to further improve the recognition accuracy of the trained audio recognition method and further improve the training efficiency.

It may be understood that the streaming multi-layer truncated attention sub-model in the present disclosure has been described in detail above. Some implementations of obtaining the sample peak information of the audio feature will be described in detail below in conjunction with related embodiments.

It may be understood that the sample peak information of the audio feature may be obtained using the connectionist temporal classification sub-model. As mentioned above, the connectionist temporal classification sub-model may be a multi-valued connectionist temporal classification sub-model or a binary connectionist temporal classification sub-model.

In some embodiments, the sample peak information of the audio feature may be obtained by using a multi-valued connectionist temporal classification sub-model.

In some other embodiments, the sample peak information of the audio feature may also be obtained by using a binary connectionist temporal classification sub-model.

In some embodiments, the audio recognition model includes a classification sub-model. For example, the classification sub-model may be a binary connectionist temporal classification sub-model.

In some embodiments, obtaining the sample peak sub-information corresponding to the first audio sequence feature according to the sample peak information of the audio feature may include: inputting the audio feature into the classification sub-model to obtain the sample peak information of the audio feature; and obtaining the sample peak sub-information corresponding to the first audio sequence feature according to the sample peak information and the first audio sequence feature.

In embodiments of the present disclosure, the sample peak information is used to indicate the peak corresponding to the audio feature, and the sample peak corresponds to a predetermined value. For example, the predetermined value may be 1.

In embodiments of the present disclosure, the predetermined value is used to indicate that the sample peak corresponds to a semantic unit, and different sample peaks correspond to a same predetermined value. For example, the semantic unit may be a word, a phone, a syllable or a word piece, etc. For another example, the predetermined values corresponding to different peaks may all be 1.

In embodiments of the present disclosure, the binary connectionist temporal classification sub-model may determine whether an audio sub-feature of the second audio feature corresponds to a semantic unit or not. For example, taking the semantic unit being a Chinese character as an example, the binary connectionist temporal classification sub-model may determine whether one or more audio sub-features correspond to a complete Chinese character. If it is determined that one or more audio sub-features correspond to a complete Chinese character, a predetermined value (for example, 1) is output to generate a sample peak. If it is determined that one or more audio sub-features do not correspond to a complete Chinese character, another predetermined value (for example, 0) is output without generating a sample peak. The binary connectionist temporal classification sub-model may be trained, so that the trained binary connectionist temporal classification sub-model may accurately determine whether one or more audio sub-features correspond to a complete semantic unit or not.

Through embodiments of the present disclosure, the classification sub-model and the recognition sub-model may be trained separately, and a parameter of the binary connectionist temporal classification sub-model and a parameter of the streaming multi-layer truncated attention sub-model may be completely independent of each other. For different speech interaction scenarios, the binary connectionist temporal classification sub-model may be specially optimized without affecting the overall recognition accuracy of the audio recognition model. The online speech interaction scenarios may be rich and diverse, and the binary connectionist temporal classification sub-model may help to achieve a rapid adaptation and iteration of the audio recognition model.

In some embodiments, the audio feature may include M audio sub-features, and the audio sub-feature corresponds to a time instant, where M is an integer less than or equal to 1. For example, if the above-mentioned target audio data is used as sample audio data, M may not be less than N.

In some embodiments, the connectionist temporal classification sub-model may include a plurality of classification networks. The classification network may include a time masking unit and a convolutional unit.

In some embodiments, the connectionist temporal classification sub-model may include a plurality of classification networks. The classification network may include a time masking unit and a convolutional unit. For example, the classification network may include a third feed-forward unit, a time masking unit, a convolutional unit, and a fourth feed-forward unit.

In some embodiments, inputting the audio feature into the classification sub-model to obtain the sample peak information of the audio feature may include: inputting the audio feature into the time masking unit of the classification sub-model to obtain a time-masked feature. In embodiments of the present disclosure, the time-masked feature corresponds to a 1^{st} audio sub-feature to an n^{th} audio sub-feature, where n is an integer greater than 1 and less than M.

For example, a second audio feature is input into the third feed-forward unit to obtain a processed second audio feature. The processed second audio feature is fused with the second audio feature to obtain a first fusion feature. The first fusion feature is input into the time masking unit to obtain a time-masked feature. The time-masked feature may correspond to the 1^{st} audio sub-feature to the n^{th} audio sub-feature. The 1^{st} audio sub-feature may correspond to a start time instant at which the sample audio data is acquired. The n^{th} audio sub-feature may correspond to the 1^{st} second. It may be understood that the second audio feature further includes audio sub-features corresponding to a plurality of time instants after the 1^{st} second. In the training stage, the time-masked feature obtained by the masking is independent of the audio sub-feature corresponding to an (n+1)^{th} time instant, so that the historical information before the n^{th} time instant may be used in the process of determining the sample peak information to meet the requirement of the online speech interaction scenario.

For another example, the time masking unit may be a time masking unit based on multi-head self-attention.

In some embodiments, inputting the audio feature into the classification sub-model to obtain the sample peak information of the audio feature may include: obtaining the sample peak information corresponding to n time instants according to the time-masked feature. In embodiments of the present disclosure, obtaining the sample peak information corresponding to n time instants according to the time-masked feature may include: inputting the time-masked feature into the convolutional unit of the classification sub-model to obtain a convoluted time-masked feature; and obtaining the sample peak information corresponding to n time instants according to the convoluted time-masked feature.

For example, the time-masked feature may be fused with the first fusion feature to obtain a second fusion feature. The second fusion feature may be input into the convolutional unit to obtain the convoluted time-masked feature. The convoluted time-masked feature is fused with the second fusion feature to obtain a third fusion feature. The third fusion feature is input into the fourth feed-forward unit to obtain a processed time-masked feature. The processed time-masked feature is fused with the third fusion feature to obtain a fourth fusion feature. It may be understood that the fourth fusion feature may be processed using a fully connected layer to obtain the sample peak information corresponding to the n time instants. In an example, if the n^{th} audio sub-feature corresponds to the 1^{st} second, the sample peak information corresponding to the n time instants may be used as the sample peak sub-information corresponding to the 1^{st} first audio sequence feature.

It may be understood that the above-mentioned convolutional unit may be a causal convolutional unit. Through embodiments of the present disclosure, based on the time masking and the causal convolution, it is possible to simultaneously pay attention to a global information and a local information of the audio feature, which helps to improve a description ability of the classification network.

It may be understood that the audio recognition model may be trained using a plurality of sample audio data and their labels simultaneously. A detailed description will be given below.

In some embodiments, the number of sample audio data may be multiple, and the number of audio features may be multiple. For example, the number of sample audio data is two, and the number of audio features is two.

In some embodiments, performing at least one decoding operation on the first audio sequence feature by using the recognition sub-model may include: performing at least one decoding operation in parallel on the first audio sequence features obtained respectively from a plurality of audio features.

For example, taking the number of sample audio data being multiple as an example, when the plurality of sample audio data are simultaneously acquired, the audio features of the plurality of sample audio data may be truncated respectively to obtain 1^{st} first audio sequence features of the plurality of sample audio data. The numbers of times the decoding operation is performed on the first audio sequence features may be respectively determined according to the sample peak sub-information respectively corresponding to these first audio sequence features. Then, at least one decoding operation may be performed on the first audio sequence features respectively by using a plurality of computing units of a graphics processing unit deployed with the recognition sub-models. Through embodiments of the present disclosure, parallel training may be performed using a plurality of sample audio data, which effectively improves the training efficiency.

In some embodiments, the first audio sequence feature includes J audio sequence sub-features, where J is an integer greater than 1. For example, taking J=5 as an example, the (k−1)^{th} first audio sequence feature may include five audio sequence sub-features.

In some embodiments, the k^{th} first audio sequence feature includes a (J−H)^{th} audio sequence sub-features of the (k−1)^{th} first audio sequence feature, where H is an integer greater than or equal to 0. For example, taking J=5 and H=0 as an example, the k^{th} first audio sequence feature may include a 5^{th} audio sequence sub-feature of the (k−1)^{th} first audio sequence feature. The k^{th} first audio sequence feature may further include the other four audio sequence sub-features.

It may be understood that, in a case that there is an overlap between two adjacent first audio sequence features, the sample peak sub-information corresponding to the (k−1)^{th} first audio sequence feature may be the sample peak sub-information corresponding to the 1^{st} audio sequence sub-feature to the (J−H)^{th} audio sequence sub-feature of the (k−1)^{th} first audio sequence feature. The sample peak sub-information corresponding to the k^{th} first audio sequence feature may be the sample peak sub-information corresponding to the 1^{st} audio sequence sub-feature to the (J−H)^{th} audio sequence sub-feature of the k^{th} first audio sequence feature.

In some embodiments, performing at least one decoding operation on the first audio sequence feature by using the recognition sub-model may include: performing at least one decoding operation in parallel on the at least one first audio sequence feature respectively by using the recognition sub-model. For example, at least one decoding operation may be performed in parallel on the at least one first audio sequence feature respectively by using different computing units of a graphics processing unit deployed with the recognition sub-model.

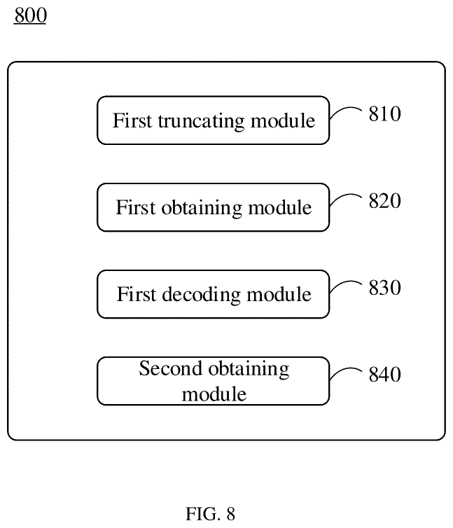

FIG. 8 shows a block diagram of an image recognition apparatus according to an embodiment of the present disclosure.

As shown in FIG. 8, the apparatus 800 may include a first truncating module 810, a first obtaining module 820, a first decoding module 830, and a second obtaining module 840.

The first truncating module 810 is used to truncate an audio feature of target audio data to obtain at least one first audio sequence feature. For example, a duration corresponding to the at least one first audio sequence feature is a predetermined duration.

The first obtaining module 820 is used to obtain, according to a peak information of the audio feature, a peak sub-information corresponding to the first audio sequence feature. For example, the peak sub-information indicates a peak corresponding to the first audio sequence feature.

The first decoding module 830 is used to perform at least one decoding operation on the first audio sequence feature to obtain a recognition result for the first audio sequence feature. For example, a number of times the decoding operation is performed is identical to a number of the peaks corresponding to the first audio sequence feature.

The second obtaining module 840 is used to obtain target text data for the target audio data according to the recognition result for the at least one first audio sequence feature.

In some embodiments, the number of first audio sequence features is K, a recognition result for a k^{th} first audio sequence feature among K first audio sequence features includes I recognition sub-results, the k^{th} first audio sequence feature corresponds to I peaks, I is an integer greater than or equal to 1, k is an integer greater than or equal to 1 and less than or equal to K, and K is an integer greater than 1.

In some embodiments, the first decoding module includes: a first decoding sub-module used to perform an i^{th} decoding operation on the k^{th} first audio sequence feature according to an (i−1)^{th} decoding parameter information of the k^{th} first audio sequence feature, so as to obtain an i^{th} decoding parameter information of the k^{th} first audio sequence feature and an i^{th} recognition sub-result for the k^{th} first audio sequence feature. For example, i is an integer greater than 1 and less than or equal to I.

In some embodiments, the first decoding module includes: a second decoding sub-module used to perform a 1^{st} decoding operation on the k^{th} first audio sequence feature according to an initial decoding parameter information of the k^{th} first audio sequence feature, so as to obtain a 1^{st} decoding parameter information of the k^{th} first audio sequence feature and a 1^{st} recognition sub-result for the k^{th} first audio sequence feature.

In some embodiments, I is an integer greater than 1, and the first decoding sub-module includes: a first decoding unit used to perform an I^{th} decoding operation on the k^{th} first audio sequence feature according to an (I−1)^{th} decoding parameter information of the k^{th} first audio sequence feature, so as to obtain an I^{th} decoding parameter information of the k^{th} first audio sequence feature and an I^{th} recognition sub-result for the k^{th} first audio sequence feature.

In some embodiments, the first decoding unit is further used to: in a case that k is less than K, use the I^{th} decoding parameter information of the k^{th} first audio sequence feature as an initial decoding parameter information of a (k+1)^{th} first audio sequence feature.

In some embodiments, the first decoding module includes: a third decoding sub-module used to perform, in response to a determination that the first audio sequence feature meets a recognition start condition, the at least one decoding operation on the first audio sequence feature according to a first predetermined decoding parameter information, so as to obtain an original decoding parameter information and the recognition result for the first audio sequence feature.

In some embodiments, the second obtaining module includes a fourth decoding sub-module used to: perform, in response to a second audio sequence feature being truncated from the audio feature, at least one decoding operation on the second audio sequence feature according to a second predetermined decoding parameter information, so as to obtain a recognition result for the second audio sequence feature, where the second audio sequence feature meets a recognition end condition; and obtain the target text data according to the recognition result for the at least one first audio sequence feature and the recognition result for the second audio sequence feature.

In some embodiments, the first decoding module includes: a first encoding sub-module used to encode the k^{th} first audio sequence feature to obtain a k^{th} initial audio sequence encoding feature; a first obtaining sub-module used to obtain a k^{th} target audio sequence encoding feature according to the k^{th} initial audio sequence encoding feature; and a fifth decoding sub-module used to perform, according to the peak sub-information corresponding to the k^{th} first audio sequence feature, at least one decoding operation on the k^{th} target audio sequence encoding feature to obtain the recognition result.

In some embodiments, the first obtaining sub-module includes: a first obtaining unit used to obtain the k^{th} target audio sequence encoding feature according to the k^{th} initial audio sequence encoding feature and a historical feature related to the k^{th} first audio sequence feature.

In some embodiments, the first decoding module includes: a second obtaining sub-module used to obtain a 1^{st} historical sub-feature of the k^{th} first audio sequence feature according to the k^{th} initial audio sequence encoding feature and a 1^{st} recognition sub-result for the k^{th} first audio sequence feature; a third obtaining sub-module used to obtain an i^{th} historical sub-feature of the k^{th} first audio sequence feature according to the k^{th} initial audio sequence encoding feature and an i recognition sub-result for the k^{th} first audio sequence feature, where i is an integer greater than 1 and less than or equal to I; and a first fusion sub-module used to fuse I historical sub-features of the k^{th} first audio sequence feature and the historical feature related to the k^{th} first audio sequence feature to obtain a historical feature related to a (k+1)^{th} first audio sequence feature.

In some embodiments, the first obtaining module includes: a fourth obtaining sub-module used to obtain the peak information of the audio feature according to the audio feature, where the peak information indicates a peak corresponding to the audio feature, and the peak corresponds to a predetermined value; and a fifth obtaining sub-module used to obtain the peak sub-information corresponding to the first audio sequence feature according to the peak information and the first audio sequence feature.

In some embodiments, the predetermined value indicates that the peak corresponds to a semantic unit, and predetermined values corresponding to different peaks are identical to each other.

In some embodiments, the audio feature includes N audio sub-features, the audio sub-feature corresponds to a time instant, and N is an integer greater than or equal to 1. The fourth obtaining sub-module includes: a first time masking unit used to perform a time masking on the audio feature to obtain a time-masked feature, where the time-masked feature corresponds to a 1^{st} audio sub-feature to an n^{th} audio sub-feature, and n is an integer greater than 1 and less than N; and a second obtaining unit used to obtain, according to the time-masked feature, the peak information corresponding to n time instants.

In some embodiments, the second obtaining unit includes: a first convolutional sub-unit used to perform a convolution on the time-masked feature to obtain a convoluted time-masked feature; and a first obtaining sub-unit used to obtain the peak information corresponding to the n time instants according to the convoluted time-masked feature.

In some embodiments, the first truncating module includes: a first convolutional sub-module used to perform a convolution on the audio feature to obtain a first audio feature; and a first truncating sub-module used to truncate the first audio feature.

In some embodiments, the first truncating sub-module is further used to truncate the first audio feature in response to a determination that a duration corresponding to the first audio feature meets a predetermined duration condition.

In some embodiments, the first obtaining module includes: a second convolutional sub-module used to perform a convolution on the audio feature to obtain a second audio feature; and a sixth obtaining sub-module used to obtain the peak sub-information corresponding to the first audio sequence feature according to a peak information of the second audio feature.

In some embodiments, the number of target audio data is multiple, and the number of audio features is multiple. The first decoding module includes: a first parallel-decoding sub-module used to perform the at least one decoding operation in parallel on the first audio sequence features respectively obtained from the plurality of audio features.

In some embodiments, the first audio sequence feature includes J audio sequence sub-features, and J is an integer greater than 1; and the k^{th} first audio sequence feature includes a (J−H)^{th} audio sequence sub-feature of a (k−1)^{th} first audio sequence feature, and H is an integer greater than or equal to 0.

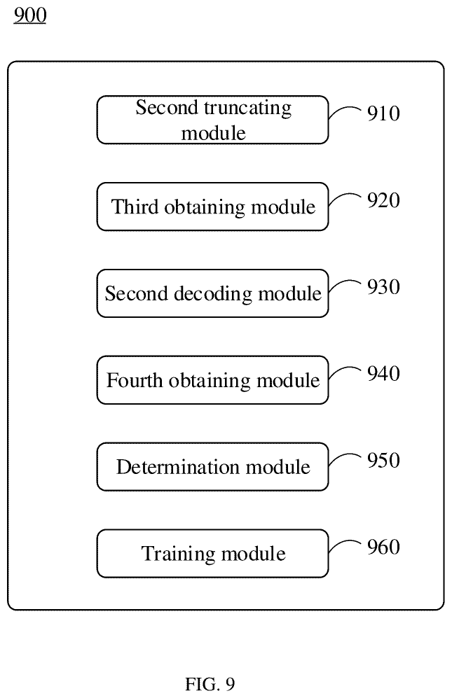

FIG. 9 shows a block diagram of an apparatus of training an audio recognition model according to an embodiment of the present disclosure.

In embodiments of the present disclosure, the audio recognition model includes a recognition sub-model.

As shown in FIG. 9, the apparatus 900 may include a second truncating module 910, a third obtaining module 920, a second decoding module 930, a fourth obtaining module 940, a determination module 950, and a training module 960.

The second truncating module 910 is used to truncate an audio feature of sample audio data by using the recognition sub-model, so as to obtain at least one first audio sequence feature. For example, a duration corresponding to the at least one first audio sequence feature is a predetermined duration.

The third obtaining module 920 is used to obtain, according to a sample peak information of the audio feature, a sample peak sub-information corresponding to the first audio sequence feature. For example, the sample peak sub-information indicates a sample peak corresponding to the first audio sequence feature.

The second decoding module 930 is used to perform at least one decoding operation on the first audio sequence feature by using the recognition sub-model, so as to obtain a recognition result for the first audio sequence feature. For example, a number of times the decoding operation is performed is identical to a number of the sample peaks corresponding to the first audio sequence feature.

The fourth obtaining module 940 is used to obtain sample text data for the sample audio data according to the recognition result for the at least one first audio sequence feature.

The determination module 950 is used to determine a recognition loss value according to the sample text data and a recognition sub-label of the sample audio data.

The training module 960 is used to train the audio recognition model according to the recognition loss value.

In some embodiments, the number of first audio sequence features is K, a recognition result for a k^{th} first audio sequence feature among K first audio sequence features includes I recognition sub-results, the k^{th} first audio sequence feature corresponds to I sample peaks, I is an integer greater than or equal to 1, k is an integer greater than or equal to 1 and less than or equal to K, and K is an integer greater than 1.

In some embodiments, the recognition sub-model includes a decoding network, and the second decoding module includes: a sixth decoding sub-module used to perform, by using the decoding network, an i^{th} decoding operation on the k^{th} first audio sequence feature according to an (i−1)^{th} decoding parameter information of the k^{th} first audio sequence feature, so as to obtain an i^{th} decoding parameter information of the k^{th} first audio sequence feature and an i^{th} recognition sub-result for the k^{th} first audio sequence feature. For example, i is an integer greater than 1 and less than or equal to I.

In some embodiments, the second decoding module includes: a seventh decoding sub-module used to perform, by using the decoding network, a 1^{st} decoding operation on the k^{th} first audio sequence feature according to an initial decoding parameter information of the k^{th} first audio sequence feature, so as to obtain a 1^{st} decoding parameter information of the k^{th} first audio sequence feature and a 1^{st} recognition sub-result for the k^{th} first audio sequence feature.

In some embodiments, I is an integer greater than 1, and the sixth decoding sub-module includes: a second decoding unit used to perform, by using the decoding network, an I^{th} decoding operation on the k^{th} first audio sequence feature according to an (I−1)^{th} decoding parameter information of the k^{th} first audio sequence feature, so as to obtain an I^{th} decoding parameter information of the k^{th} first audio sequence feature and an I^{th} recognition sub-result for the k^{th} first audio sequence feature.

In some embodiments, the second decoding unit is further used to: in a case that k is less than K, use the I^{th} decoding parameter information of the k^{th} first audio sequence feature as an initial decoding parameter information of a (k+1)^{th} first audio sequence feature.

In some embodiments, the recognition sub-model includes a decoding network, and the second decoding module includes: an eighth decoding sub-module used to perform, in response to a determination that the first audio sequence feature meets a recognition start condition, the at least one decoding operation on the first audio sequence feature by using the decoding network according to a first predetermined decoding parameter information, so as to obtain an original decoding parameter information and the recognition result for the first audio sequence feature.

In some embodiments, the recognition sub-model includes a decoding network, and the fourth obtaining module includes a ninth decoding sub-module used to: perform, in response to a second audio sequence feature being truncated from the audio feature, at least one decoding operation on the second audio sequence feature by using the decoding network according to a second predetermined decoding parameter information, so as to obtain a recognition result for the second audio sequence feature, where the second audio sequence feature meets a recognition end condition; and obtain the sample text data according to the recognition result for the at least one first audio sequence feature and the recognition result for the second audio sequence feature.

In some embodiments, the recognition sub-model includes an encoding network and a decoding network, and the second decoding module includes: a second encoding sub-module used to encode the k^{th} first audio sequence feature by using a first feed-forward unit of the encoding network, so as to obtain a k^{th} initial audio sequence encoding feature; a seventh obtaining sub-module used to process the k^{th} initial audio sequence encoding feature by using an encoding unit of the encoding network, so as to obtain a k^{th} target audio sequence encoding feature; and a tenth decoding sub-module used to perform, according to the sample peak sub-information corresponding to the k^{th} first audio sequence feature, at least one decoding operation on the k^{th} target audio sequence encoding feature by using the decoding network, so as to obtain the recognition result.

In some embodiments, the seventh obtaining sub-module includes: a third obtaining unit used to process the k^{th} initial audio sequence encoding feature and a historical feature related to the k^{th} first audio sequence feature by using the encoding unit, so as to obtain the k^{th} target audio sequence encoding feature.

In some embodiments, the second decoding module includes: an eighth obtaining sub-module used to obtain a 1^{st} historical sub-feature of the k^{th} first audio sequence feature according to the k^{th} initial audio sequence encoding feature and a 1^{st} recognition sub-result for the k^{th} first audio sequence feature; a ninth obtaining sub-module used to obtain an i^{th} historical sub-feature of the k^{th} first audio sequence feature according to the k^{th} initial audio sequence encoding feature and an i^{th} recognition sub-result for the k^{th} first audio sequence feature, where i is an integer greater than 1 and less than or equal to I; and a second fusion sub-module used to fuse I historical sub-features of the k^{th} first audio sequence feature and the historical feature related to the k^{th} first audio sequence feature to obtain a historical feature related to a (k+1)^{th} first audio sequence feature.

In some embodiments, the audio recognition model includes a classification sub-model, and the third obtaining module includes: a tenth obtaining sub-module used to input the audio feature into the classification sub-model to obtain the sample peak information of the audio feature, where the sample peak information indicates a sample peak corresponding to the audio feature, and the sample peak corresponds to a predetermined value; and an eleventh obtaining sub-module used to obtain the sample peak sub-information corresponding to the first audio sequence feature according to the sample peak information and the first audio sequence feature.

In some embodiments, the predetermined value indicates that the sample peak corresponds to a semantic unit, and predetermined values corresponding to different sample peaks are identical to each other.

In some embodiments, the audio feature includes M audio sub-features, the audio sub-feature corresponds to a time instant, and M is an integer greater than or equal to 1. The tenth obtaining sub-module includes: a second time masking unit used to input the audio feature into a time masking unit of the classification sub-model to obtain a time-masked feature, where the time-masked feature corresponds to a 1^{st} audio sub-feature to an n^{th} audio sub-feature, and n is an integer greater than 1 and less than M; and a fourth obtaining unit used to obtain, according to the time-masked feature, the sample peak information corresponding to n time instants.

In some embodiments, the fourth obtaining unit includes: a second convolutional sub-unit used to input the time-masked feature into a convolutional unit of the classification sub-model to obtain a convoluted time-masked feature; and a second obtaining sub-unit used to obtain the sample peak information corresponding to the n time instants according to the convoluted time-masked feature.

In some embodiments, the second truncating module includes: a third convolutional sub-module used to input the audio feature into a first convolutional sub-model of the audio recognition model to obtain a first audio feature; and a second truncating sub-module used to truncate the first audio feature by using the recognition sub-model.

In some embodiments, the second truncating sub-module is further used to: truncate the first audio feature by using the recognition sub-model in response to a determination that a duration corresponding to the first audio feature meets a predetermined duration condition.

In some embodiments, the third obtaining module includes: a fourth convolutional sub-module used to input the audio feature into a second convolutional sub-model of the audio recognition model to obtain a second audio feature; and an eleventh obtaining sub-module used to obtain the sample peak sub-information corresponding to the first audio sequence feature according to a sample peak information of the second audio feature.

In some embodiments, the number of sample audio data is multiple, and the number of audio features is multiple. The second decoding module includes: a second parallel-decoding sub-module used to perform, by using the plurality of recognition sub-models, the at least one decoding operation in parallel on the first audio sequence features respectively obtained from the plurality of audio features.

In some embodiments, the first audio sequence feature includes J audio sequence sub-features, and J is an integer greater than 1; and the k^{th} first audio sequence feature includes a (J−H)^{th} audio sequence sub-feature of a (k−1)^{th} first audio sequence feature, and H is an integer greater than or equal to 0.

In some embodiments, the second decoding module includes: a third parallel-decoding sub-module used to perform the at least one decoding operation in parallel on the at least one first audio sequence feature respectively by using at least one recognition sub-model.

In some embodiments, the recognition sub-label indicates text data corresponding to the sample audio data.

In some embodiments, the training module includes: a determination sub-module used to determine a classification loss value according to the sample peak information and a classification sub-label of the sample audio data, where the classification sub-label indicates a real peak corresponding to the sample audio data, and the real peak corresponds to a semantic unit; and a training sub-module used to train the audio recognition model according to the classification loss value and the recognition loss value.

According to embodiments of the present disclosure, the present disclosure further provides an electronic device, a readable storage medium, and a computer program product.

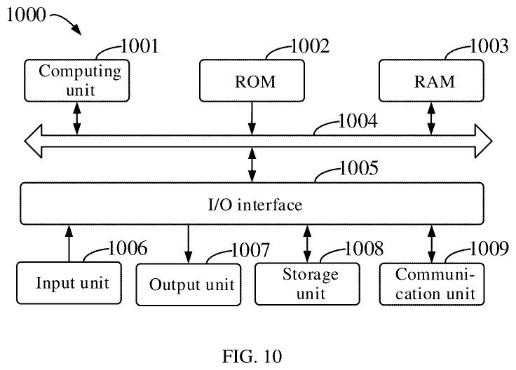

FIG. 10 shows a schematic block diagram of an example electronic device 1000 for implementing embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 10, the electronic device 1000 includes a computing unit 1001 which may perform various appropriate actions and processes according to a computer program stored in a read only memory (ROM) 1002 or a computer program loaded from a storage unit 1008 into a random access memory (RAM) 1003. In the RAM 1003, various programs and data necessary for an operation of the electronic device 1000 may also be stored. The computing unit 1001, the ROM 1002 and the RAM 1003 are connected to each other through a bus 1004. An input/output (I/O) interface 1005 is also connected to the bus 1004.

A plurality of components in the electronic device 1000 are connected to the I/O interface 1005, including: an input unit 1006, such as a keyboard, or a mouse; an output unit 1007, such as displays or speakers of various types; a storage unit 1008, such as a disk, or an optical disc; and a communication unit 1009, such as a network card, a modem, or a wireless communication transceiver. The communication unit 1009 allows the electronic device 1000 to exchange information/data with other devices through a computer network such as Internet and/or various telecommunication networks.

The computing unit 1001 may be various general-purpose and/or dedicated processing assemblies having processing and computing capabilities. Some examples of the computing units 1001 include, but are not limited to, a central processing unit (CPU), a graphics processing unit (GPU), various dedicated artificial intelligence (AI) computing chips, various computing units that run machine learning model algorithms, a digital signal processing processor (DSP), and any suitable processor, controller, microcontroller, etc. The computing unit 1001 executes various methods and processes described above, such as the audio recognition method and/or the method of training the audio recognition model. For example, in some embodiments, the audio recognition method and/or the method of training the audio recognition model may be implemented as a computer software program which is tangibly embodied in a machine-readable medium, such as the storage unit 1008. In some embodiments, the computer program may be partially or entirely loaded and/or installed in the electronic device 1000 via the ROM 1002 and/or the communication unit 1009. The computer program, when loaded in the RAM 1003 and executed by the computing unit 1001, may execute one or more steps in the audio recognition method and/or the method of training the audio recognition model described above. Alternatively, in other embodiments, the computing unit 1001 may be used to perform the audio recognition method and/or the method of training the audio recognition model by any other suitable means (e.g., by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from a storage system, at least one input device and at least one output device, and may transmit the data and instructions to the storage system, the at least one input device, and the at least one output device.

Program codes for implementing the methods of the present disclosure may be written in one programming language or any combination of more programming languages. These program codes may be provided to a processor or controller of a general-purpose computer, a dedicated computer or other programmable data processing apparatus, such that the program codes, when executed by the processor or controller, cause the functions/operations specified in the flowcharts and/or block diagrams to be implemented. The program codes may be executed entirely on a machine, partially on a machine, partially on a machine and partially on a remote machine as a stand-alone software package or entirely on a remote machine or server.

In the context of the present disclosure, a machine-readable medium may be a tangible medium that may contain or store a program for use by or in connection with an instruction execution system, an apparatus or a device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer disk, a hard disk, a random access memory (RAM), a read only memory (ROM), an erasable programmable read only memory (EPROM or a flash memory), an optical fiber, a compact disk read only memory (CD-ROM), an optical storage device, a magnetic storage device, or any suitable combination of the above.

In order to provide interaction with the user, the systems and technologies described here may be implemented on a computer including a display device (for example, a CRT (cathode ray tube) or LCD (liquid crystal display) monitor) for displaying information to the user, and a keyboard and a pointing device (for example, a mouse or a trackball) through which the user may provide the input to the computer. Other types of devices may also be used to provide interaction with the user. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and the Internet.

The computer system may include a client and a server. The client and the server are generally far away from each other and usually interact through a communication network. A relationship between the client and the server is generated through computer programs running on the corresponding computers and having a client-server relationship with each other.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. An audio recognition method, comprising:
truncating an audio feature of target audio data to obtain at least one first audio sequence feature, wherein a duration corresponding to the at least one first audio sequence feature is a predetermined duration;
obtaining, according to a peak information of the audio feature, a peak sub-information corresponding to the first audio sequence feature, wherein the peak sub-information indicates a peak corresponding to the first audio sequence feature;
performing at least one decoding operation on the first audio sequence feature to obtain a recognition result for the first audio sequence feature, wherein a number of times the decoding operation is performed is identical to a number of peaks corresponding to the first audio sequence feature; and
obtaining target text data for the target audio data according to the recognition result for the at least one first audio sequence feature.

2. The method according to claim 1, wherein a number of first audio sequence features is K, a recognition result for a k^{th} first audio sequence feature among K first audio sequence features comprises I recognition sub-results, the k^{th} first audio sequence feature corresponds to I peaks, wherein I is an integer greater than or equal to 1, k is an integer greater than or equal to 1 and less than or equal to K, and K is an integer greater than 1.

3. The method according to claim 2, wherein the performing at least one decoding operation on the first audio sequence feature comprises:
performing an i^{th} decoding operation on the k^{th} first audio sequence feature according to an (i−1)^{th} decoding parameter information of the k^{th} first audio sequence feature, so as to obtain an i^{th} decoding parameter information of the k^{th} first audio sequence feature and an i^{th} recognition sub-result for the k^{th} first audio sequence feature, wherein i is an integer greater than 1 and less than or equal to I.

4. The method according to claim 2, wherein the performing at least one decoding operation on the first audio sequence feature comprises:
performing a 1^{st} decoding operation on the k^{th} first audio sequence feature according to an initial decoding parameter information of the k^{th} first audio sequence feature, so as to obtain a 1^{st} decoding parameter information of the k^{th} first audio sequence feature and a 1^{st} recognition sub-result for the k^{th} first audio sequence feature.

5. The method according to claim 3, wherein I is an integer greater than 1, and the performing an i^{th} decoding operation on the k^{th} first audio sequence feature comprises:
performing an I^{th} decoding operation on the k^{th} first audio sequence feature according to an (I−1)^{th} decoding parameter information of the k^{th} first audio sequence feature, so as to obtain an I^{th} decoding parameter information of the k^{th} first audio sequence feature and an I^{th} recognition sub-result for the k^{th} first audio sequence feature.

6. The method according to claim 5, wherein the performing an I^{th} decoding operation on the k^{th} first audio sequence feature further comprises:
in a case that k is less than K, using the I^{th} decoding parameter information of the k^{th} first audio sequence feature as an initial decoding parameter information of a (k+1)^{th} first audio sequence feature.

7. The method according to claim 1, wherein the performing at least one decoding operation on the first audio sequence feature comprises:
performing, in response to a determination that the first audio sequence feature meets a recognition start condition, the at least one decoding operation on the first audio sequence feature according to a first predetermined decoding parameter information, so as to obtain an original decoding parameter information and the recognition result for the first audio sequence feature.

8. The method according to claim 1, wherein the obtaining target text data for the target audio data according to the recognition result for the at least one first audio sequence feature comprises:
performing, in response to a second audio sequence feature being truncated from the audio feature, at least one decoding operation on the second audio sequence feature according to a second predetermined decoding parameter information, so as to obtain a recognition result for the second audio sequence feature, wherein the second audio sequence feature meets a recognition end condition; and
obtaining the target text data according to the recognition result for the at least one first audio sequence feature and the recognition result for the second audio sequence feature.

9. The method according to claim 2, wherein the performing at least one decoding operation on the first audio sequence feature comprises:
encoding the k^{th} first audio sequence feature to obtain a k^{th} initial audio sequence encoding feature;
obtaining a k^{th} target audio sequence encoding feature according to the k^{th} initial audio sequence encoding feature; and
performing at least one decoding operation on the k^{th} target audio sequence encoding feature to obtain the recognition result for the first audio sequence feature.

10. The method according to claim 9, wherein the obtaining a k^{th} target audio sequence encoding feature according to the k^{th} initial audio sequence encoding feature comprises:
obtaining the k^{th} target audio sequence encoding feature according to the k^{th} initial audio sequence encoding feature and a historical feature related to the k^{th} first audio sequence feature.

11. The method according to claim 9, wherein the performing at least one decoding operation on the first audio sequence feature comprises:
obtaining a 1^{st} historical sub-feature of the k^{th} first audio sequence feature according to the k^{th} initial audio sequence encoding feature and a 1^{st} recognition sub-result for the k^{th} first audio sequence feature;
obtaining an i^{th} historical sub-feature of the k^{th} first audio sequence feature according to the k^{th} initial audio sequence encoding feature and an i^{th} recognition sub-result for the k^{th} first audio sequence feature, wherein i is an integer greater than 1 and less than or equal to I; and
fusing I historical sub-features of the k^{th} first audio sequence feature and the historical feature related to the k^{th} first audio sequence feature to obtain a historical feature related to a (k+1)^{th} first audio sequence feature.

12. The method according to claim 1, wherein the obtaining a peak sub-information corresponding to the first audio sequence feature according to a peak information of the audio feature comprises:
obtaining the peak information of the audio feature according to the audio feature, wherein the peak information indicates a peak corresponding to the audio feature, and the peak corresponds to a predetermined value; and
obtaining the peak sub-information corresponding to the first audio sequence feature according to the peak information and the first audio sequence feature.

13. The method according to claim 12, wherein the predetermined value indicates that the peak corresponds to a semantic unit, and predetermined values corresponding to different peaks are identical to each other.

14. The method according to claim 12, wherein the audio feature comprises N audio sub-features, the audio sub-feature corresponds to a time instant, and N is an integer greater than or equal to 1, and
wherein the obtaining the peak information of the audio feature according to the audio feature comprises:
performing a time masking on the audio feature to obtain a time-masked feature, wherein the time-masked feature corresponds to a 1^{st} audio sub-feature to an n^{th} audio sub-feature, and n is an integer greater than 1 and less than N; and
obtaining, according to the time-masked feature, peak information corresponding to n time instants, and
wherein the obtaining peak information corresponding to n time instants according to the time-masked feature comprises:
performing a convolution on the time-masked feature to obtain a convoluted time-masked feature; and
obtaining the peak information corresponding to the n time instants according to the convoluted time-masked feature.

15. The method according to claim 1, wherein the truncating an audio feature of target audio data comprises:
performing a convolution on the audio feature to obtain a first audio feature; and
truncating the first audio feature, and
wherein the truncating the first audio feature comprises:
truncating the first audio feature in response to a determination that a duration corresponding to the first audio feature meets a predetermined duration condition.

16. The method according to claim 1, wherein the obtaining a peak sub-information corresponding to the first audio sequence feature according to a peak information of the audio feature comprises:
performing a convolution on the audio feature to obtain a second audio feature; and
obtaining the peak sub-information corresponding to the first audio sequence feature according to a peak information of the second audio feature.

17. The method according to claim 1, wherein a number of target audio data is multiple, and a number of audio features is multiple, and
wherein the performing at least one decoding operation on the first audio sequence feature comprises:
performing the at least one decoding operation in parallel on the first audio sequence features respectively obtained from the plurality of audio features.

18. The method according to claim 2, wherein the first audio sequence feature comprises J audio sequence sub-features, and J is an integer greater than 1, and
wherein the k^{th} first audio sequence feature comprises a (J−H)^{th} audio sequence sub-feature of a (k−1)^{th} first audio sequence feature, and H is an integer greater than or equal to 0.

19. A method of training an audio recognition model, wherein the audio recognition model comprises a recognition sub-model, the method comprising:
truncating an audio feature of sample audio data by using the recognition sub-model, so as to obtain at least one first audio sequence feature, wherein a duration corresponding to the at least one first audio sequence feature is a predetermined duration;
obtaining, according to a sample peak information of the audio feature, a sample peak sub-information corresponding to the first audio sequence feature, wherein the sample peak sub-information indicates a sample peak corresponding to the first audio sequence feature;
performing at least one decoding operation on the first audio sequence feature by using the recognition sub-model, so as to obtain a recognition result for the first audio sequence feature, wherein a number of times the decoding operation is performed is identical to a number of sample peaks corresponding to the first audio sequence feature;
obtaining sample text data for the sample audio data according to the recognition result for the at least one first audio sequence feature;
determining a recognition loss value according to the sample text data and a recognition sub-label of the sample audio data; and
training the audio recognition model according to the recognition loss value.

20. An electronic device, comprising:
at least one processor; and
a memory communicatively connected to the at least one processor, wherein the memory stores instructions executable by the at least one processor, and the instructions, when executed by the at least one processor, are configured to cause the at least one processor to at least:
truncate an audio feature of target audio data to obtain at least one first audio sequence feature, wherein a duration corresponding to the at least one first audio sequence feature is a predetermined duration;
obtain, according to a peak information of the audio feature, a peak sub-information corresponding to the first audio sequence feature, wherein the peak sub-information indicates a peak corresponding to the first audio sequence feature;
perform at least one decoding operation on the first audio sequence feature to obtain a recognition result for the first audio sequence feature, wherein a number of times the decoding operation is performed is identical to a number of peaks corresponding to the first audio sequence feature; and
obtain target text data for the target audio data according to the recognition result for the at least one first audio sequence feature.
